(19) United States
(12) Patent Application Publication
(10) Pub. No.: US 2005/0210009 A1
(43) Pub. Date: Sep. 22, 2005

(54) Systems and methods for intellectual property management

(76) Inventor: Bao Tran, San Jose, CA (US)

Correspondence Address: TRAN & ASSOCIATES, 6768 MEADOW VISTA CT., SAN JOSE, CA, 95135, US

(21) Appl. No.: 10/804,739

(22) Filed: Mar. 18, 2004

(51) Int. Cl. G06F 17/30; G06F 17/21; G06F 15/16; G06F 17/60

(52) U.S. Cl. 707/3; 715/512; 709/231; 705/1

(57) ABSTRACT

Systems and methods are disclosed for providing an electronic file for intellectual property applications by receiving electronic file wrapper information from a patent office; and generating a single electronic document for an entry in the electronic file wrapper information, the document having all images for the entry consolidated therein.

### BACKGROUND

The present invention relates to systems and methods for managing intellectual property documents.

The emergence of the Internet as the dominant communication medium is paralleled by the growth of intellectual property (IP). Due to the rapid dissemination of ideas over the Internet, businesses need protection for their proprietary developments. The patent process typically starts with the communication of an idea (invention) from an inventor (sometimes referred herein to as “Applicant”) to a patent practitioner. Such an idea is often communicated to patent practitioner in the form of an invention disclosure. The patent practitioner then prepares a patent application that is filed, for example, in the USPTO. After the application is received by the patent office and it is verified that all the necessary papers have been correctly completed, the application is examined by a patent examiner (hereinafter the “Examiner”). The Examiner then prepares and sends an Office Action to the applicant or the patent practitioner setting forth the patent office's initial opinion on the patentability of the invention (of course, other papers, such as a Restriction Requirement or Notice of Allowance, may be prepared and sent instead of an Office Action as appropriate). A Notification of the Office Action is then forwarded to the Applicant who may prepare Instructions to patent practitioner so that the practitioner may prepare and file an appropriate Response. This Office Action/Response cycle may be repeated one or more times until the Examiner mails a Notice of Allowance indicating the patent application is in condition for allowance. A Notification of the Notice of Allowance is mailed to Applicant who then provide Instructions to the patent practitioner to transmit the Issue Fee to the Patent Office. A few months after the Issue Fee is paid, an Issued Patent is published. U.S. Patent Law requires Maintenance Fees to be paid on an issued patent 31/2, 71/2 and 111/2 years after issuance to maintain the patent in force. Practitioners typically send Fee Reminders to Applicants about such maintenance fees. Applicants respond with Instructions to ensure that Fees are paid in a timely fashion.

Traditional methods of preparing, filing and examining patent applications and other intellectual property documents have been centered around a paper-based methodology. Throughout the above process, Applicants, patent practitioners and Patent Office each enter appropriate due dates, copy and mail papers they prepare in their internal databases to other participants in the process. For example, patent attorneys send drafts to inventors for review, and upon finalizing, the formal response is mailed to the patent office. Meanwhile, paper copies are made in each step. As can be appreciated, paper-based methodology is slow, expensive, error-prone, and is subject to being lost or misplaced. Further, it is more difficult to collaborate and/or examine the merits of an office action or a response thereto using paper-based methodology.

Due to the popularity of the Internet, patent offices such as the EPO and the USPTO are making application data available on line. For example, the US PTO offers access to application data through a system known as Patent Application Information Retrieval (PAIR). For pending and abandoned application data, the PAIR system first authenticates a user by comparing user provided Entrust/Direct™ Certificate and Customer Number to the Entrust/Direct™ Certificate and Customer Number on file in the PAIR system. Only those users who have Entrust/Direct™ Certificate and Customer Numbers which match will be allowed access to the requested data. The Private PAIR system is designed to provide data regarding the status of an application or a patent to a specific targeted audience (i.e., patent applicants and/or their designated representatives) prior to publication. After the first publication date, public users will be able to access application status via Public PAIR on the Patent Electronic Business Center web site.

PAIR Version 4.5 provides Image File Wrapper images in TIFF format. Each document consists of separate pages in standard TIFF format. Multiple documents are stored in separate subdirectories within a compressed file called a TAR file. Document images can be viewed individually using a TIFF viewer. PAIR displays documents associated with each application only when one or more document images are available for on-line viewing. After searching by application No., if one or more document images are available for on-line viewing the “Image File Wrapper” option will appear in the Private PAIR dropdown list. An applicant can select this option to display the Image File Wrapper document list. Document images can be selected and downloaded from the PAIR Image File Wrapper document list screen. PAIR will save the images in a .TAR file. The downloaded .TAR file can be opened using decompression software such as the WinZip program available at http://www.winzip.com. To download document images, individual documents are selected from the Image File Wrapper document list by placing a check in the box provided. Upon clicking the “Download” link, a “Save As” dialog box opens to allow the user to navigate to the desired folder to save the compressed .TAR file. Additionally, if the Private PAIR E-Patent Reference service is available for a particular application, the “Display References” option will appear in the Private PAIR dropdown list when viewing the search results for application No., patent No., or Publication Number. The user can view a list of electronic reference forms, sorted by Mail Date. A list of cited US references available for download in PDF format can be subsequently downloaded.

### SUMMARY

In one aspect, systems and methods are disclosed for providing an electronic file for intellectual property applications by receiving electronic file wrapper information from a patent office; and generating a single electronic document for an entry in the electronic file wrapper information, the document having all images for the entry consolidated therein.

Implementations of the above aspect can include one or more of the following. The electronic file can include a folder containing at least one file for each entry and the system periodically updates folder content with one or more new entries from the patent office electronic file wrapper information. A single electronic document can be generated for each new entry in the electronic file wrapper information, the document having all images for the entry consolidated therein. The electronic file wrapper information can include a plurality of entries each having a mail-room date and a document description and where docketing information can be based on the mail-room date. A docket entry can be generated for one or more of the following: Information Disclosure Statement filing, foreign filing, Office Action response, response to missing part, notice of appeal, appeal brief, reply to response to appeal brief, notice of allowance, and annuity payment. A docketing message can be generated and sent to a recipient. The docketing message can be coded to indicate the degree of urgency of the docketing message. The system can automatically generate and automatically file one or more electronic documents with the patent office computer. The documents that can be filed can include one or more of the following: utility patent applications, Provisional applications, Biosequence listings for applications previously filed in paper, Pre-grant publication resubmissions for previously filed applications, where the applicant wants an amended, redacted, voluntary, or republication specification to be published rather than the application as originally filed, Subsequent bio-sequence submissions, Multiple assignments, Electronic Information Disclosure Statements (eIDS), Design applications, New plant applications, Corrected or revised patent application republications, Reissue applications, International Patent Cooperation Treaty (PCT) applications, and Reexamination requests.

The system can extract dates from the patent office computer to support a docketing system for recording, tracking, and reporting deadlines associated with legal cases. The docketing system is useful for intellectual property practitioners, such as patent attorneys, who have to keep track of several deadlines related to intellectual property cases. The docketing system can keep track of deadlines related to one or more cases handled by one or more practitioners. In response to events related to the cases which result in one or more deadlines, the system automatically generates messages notifying users of deadlines associated with the events. The docketing messages are then automatically communicated to appropriate recipients using emails or the recipients' software such as Microsoft Outlook.

In another aspect, systems and methods are disclosed for providing an electronic file for intellectual property (IP) applications by searching one or more databases for one or more relevant IPs; performing a network analysis on the relevant IPs; and determining IPs required to provide freedom to operate.

Implementations of the above aspect can include one or more of the following. After the IPs have been identified, the system assists the user in acquiring the least number of IPs to provide freedom to operate. Further, the system can receive electronic file wrapper information from a patent office computer; and generate a single electronic document for an entry in the electronic file wrapper information, the document having all images for the entry consolidated therein.

In another aspect, a system to download a published application using a patent application serial number rather than the published application number includes parsing a predetermined number of digits (for example the last six digits) of the application serial number and submitting a search request to locate a published application matching the predetermined number of digits (for example the last six digits) of the application serial number.

In another aspect, a system to download IP documents includes receiving an assignee name in lieu of patent Nos. or application Ser. Nos.

Implementations of the system includes searching for issued patents and published applications matching the assignee name.

Advantages may include one or more of the following. The system electronically extracts mailing dates from the patent office to avoid mistakes in manual data entry. The electronic record from the patent office can be compared against communications received through the mail system and inaccuracies can be verified in time to avoid abandonment. Docketing messages are automatically generated and electronically communicated to the user. Patent documents are visually displayed for ease of interpretation. Each patent of interest is annotated, and the annotated document is easier to interpret since relevant information is parsed and visually provided to the user.

The system supports electronic filing and prosecution of patent applications in patent and offices worldwide as well as online receipt and examination of patent applications and issuance of office actions by patent offices worldwide, allowing all correspondence to and from patent offices to be paperless. Further, the system provides automated docketing accessible to all authorized participants, electronic notification of due dates and electronic payment of annuity fees. The system also supports coordinating, tracking and providing payment options for all financial aspects of the patent process including patent office fees, practitioner fees and service provider fees. Further, external information such as information from external documents can be incorporated in the electronic file. The system enables IP owners to have IP portfolio visibility, on-demand status reporting, and strategic IP analysis, extending not only to issued patents, but to invention disclosures and pending applications as well. The search engine allows data mining of IP portfolios and targeting of potential licensees.

### BRIEF DESCRIPTION OF THE DRAWINGS

FIGS. 1A-1D illustrate exemplary embodiments of an IP management system.

FIGS. 2A-2B illustrate exemplary flow-charts.

FIG. 3 illustrates an exemplary document format.

FIG. 4 illustrates an exemplary annotation of the drawings or the claims of a patent document.

FIG. 5 shows one exemplary environment for IP analysis.

FIG. 5 shows one exemplary environment for IP analysis.

FIG. 6 shows one embodiment for handling patent requests from a client machine.

FIG. 7 shows one embodiment of a process to map intellectual property (IP).

FIGS. 8-9 show exemplary user interfaces for IP mappings.

FIG. 10 shows an exemplary process for caching IP documents on the server.

FIGS. 11-13 show exemplary processes for distributed mapping of IPs.

FIG. 14 illustrates an exemplary IP search process.

FIGS. 15A-15D show exemplary processes for analyzing and ranking IP documents.

FIG. 16 illustrates an exemplary user interface for downloading IP documents and a browser display window for updatable message.

FIG. 17 shows one embodiment of a user registration and login user interface to support the development of an IP user community.

### DESCRIPTION

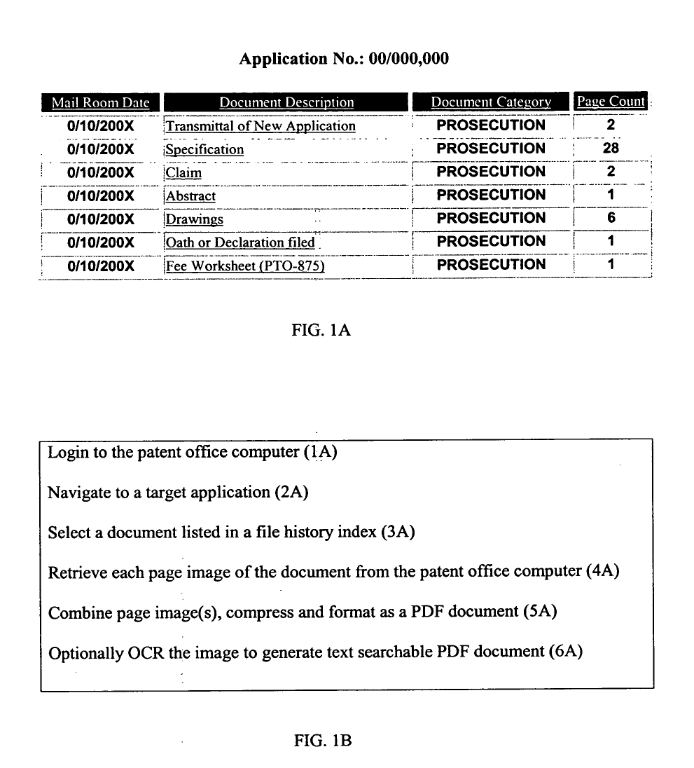

FIGS. 1A-1C show exemplary processes for maintain digital patent application documents. In general, a user interface is provided to allow a user to conveniently retrieve a particular item from a patent file history.

In one embodiment, a browser user interface allows a user to login to a patent office computer and to navigate to a particular application file. In this embodiment, the system authenticates the user by comparing user provided Entrust/Direct™ Certificate and Customer Number to the Entrust/Direct™ Certificate and Customer Number on file in the PAIR system. In other embodiments, a secure card such as a smart card and a reader is used to authenticate the user.

As shown in the exemplary user interface of FIG. 1A, when the user navigates to the page with the desired application serial number, an index for the file history wrapper is shown. In the example shown in FIG. 1A, a column entitled “Document Description” with seven documents or items entitled Transmittal of New Application, Specification, Claim, Abstract, Drawings, Oath or Declaration filed, and Fee Worksheet (PTO-875), respectively.

When the user clicks on a selected item or document listed in the index, the system retrieves each image of the document form the patent office computer, combines all page images into a single document, compresses and converts the collated page images into a portable document format such as PDF. Thus, to illustrate, if the user clicks on the link entitled “Specification”, since the Specification document has 28 pages, the system merges 28 TIFF images into a single PDF document and compresses the PDF document. The resulting PDF document is shown to the user for instant viewing of the selected item or document in the application file history wrapper. In the example with the Specification document, it is convenient and faster to scroll up/down the pages of a PDF document than to view each page using a TIFF viewer.

In one embodiment, each page image can be accessed by issuing a download request and storing all pages in a temporary directory. In this embodiment, images of pages a document are downloaded from the USPTO PAIR Image File Wrapper as a compressed file (such as a .TAR file). The downloaded .TAR file is decompressed to make each page image accessible. All page images are then combined, compressed and stored as a single PDF document for ease of reviewing.

In another embodiment, each page image is separately retrieved using a predetermined Uniform Resource Locator (URL) formula to access the page image database at the patent office. The formula can be determined by reviewing the URL issued when a “next page”/“previous page” link or button is selected. In general, the URL conforms to a predetermined format spelling out which page is being accessed. The current page designation is incremented and substituted in a predetermined part of the URL formula, and the new URL formula is issued to fetch the next page. This process is repeated until the URL-fetch results in a failure to indicate that the last page image was already retrieved. All page images are then combined, compressed and stored as a single PDF document for ease of reviewing.

FIG. 1B shows exemplary pseudo code for the above process to create a single document from a number of page images as follows:
Login to the patent office computer (1A)
Navigate to a target application (2A)
Select a document listed in a file history index (3A)
Retrieve each page image of the document from the patent office computer (4A)
Combine page image(s), compress and format as a PDF document (5A)
Optionally OCR the image to generate text searchable PDF document (6A)

In operation 6, the PDF Image and Searchable Text Conversion (formerly known as PDF plus hidden text) file contains a bitmapped image of the original, and a hidden layer of searchable text. The conversion process involves: scanning the hardcopy original, performing OCR (Optical Character Recognition) to capture the text of the document, and distilling the two layers into a PDF searchable image file.

Certain embodiments of FIG. 1B rely on the availability of the patent office computer over a network. To minimize uncertainty arising from network issues, items or documents indexed in the file wrapper are mirrored at a local computer in another embodiment. The mirrored items or documents form a digital filing system that replaces or supplements conventional paper-based files.

Additionally, the digital filing system on the local computer maintains copies of documents filed with the patent office but had not been processed to the point where the document(s) show up in the file wrapper index and images of the document(s) become available on line. For example, if the patent document (e.g., a patent application) is to be submitted electronically, the system forwards the patent document to a patent office computer over internet using a protocol previously determined by the patent office system to be acceptable for filing such documents. Generally such a protocol includes the patent office system generating a confirmation of receipt after successfully receiving the application. When the patent document is a new patent application the confirmation of receipt may include, for example, information denoting the filing date and serial number (or application number) assigned to the application. Additionally, after matching up with the file wrapper index, the copies of the filed documents can be archived to save disk space since the patent office already has one copy.

When the digital filing system receives the confirmation of receipt, it automatically enters the assigned filing date of the application into a database along with other identification information such as the application's application number or serial number. The digital filing system also saves a copy of the application as filed for proof of transmission and/or archival purposes. In this manner, a single action by the client (e.g., clicking on a “submit patent application” icon) both files the patent application and enters docketing information that can be subsequently used to create future reminder messages to maintain or pursue protection for the ideas and concepts disclosed in the patent application. These reminder messages can then later be generated by system and transmitted to appropriate client systems as described above.

In one embodiment, the filing system displays the stored files in a digital tri-fold file folder. In one implementation, communications between the client and attorney on the left side of a folder, papers filed in or received from the Patent Office in the center portion of the file and miscellaneous other papers (e.g., copies of the application as filed and/or figures) on the right side of the file.

Since new communications are periodically issued by the patent office, the mirrored files at the local computer need to be periodically synchronized. In one embodiment, the process of FIG. 1C maintains digital patent application files as follows:
Login to the patent office computer (11)
For each docket item:
   Determine application identifier for the docket item (12)
   Search patent office computer and retrieve index for application identifier (14)
   From index, determine new docket item(s) not present in a local database (16)
   Download files associated with newly identified docket items from patent office computer to local database (18):
      Retrieve each page image of the docket item from the patent office computer (20)
      Combine page image(s), compress and format as a PDF document (22)
      Optionally OCR the image to generate text searchable PDF document (24)

The document generated above may contain embedded links to other documents. For instance, an Office Action can cite to a number of prior art references. If the references are patents or documents that are digitally available, the embedded links can be clicked to bring up the reference for review. In another example, an Information Disclosure Statement (IDS) can reference a number of patents and prior art whose links can be embedded in the document. When clicked, the cited patents/prior art can be displayed in a window for user review.

FIG. 1D illustrates an embodiment of a computer system with the method and apparatus of the present invention. A computer 100 has a display device, such as a monitor 101 and an input device, such as a keyboard 103. In one embodiment, the computer 100 may be coupled to a network 102 such as a local area network (LAN) or a wide area network (WAN). The network 102 is a possible mechanism for distribution of intellectual property (IP) related documents. The network 102 can be the Internet which provides a mechanism allowing the various devices and computer systems depicted in FIG. 1D to communicate and exchange data and information with each other. The Internet may itself be comprised of many interconnected computer systems and communication links. While in one embodiment, participants communicate over the Internet, in other embodiments, communications between participants may occur over any suitable communication network including a local area network (LAN), a wide area network (WAN), a wireless network, an intranet, a private network, a public network, a switched network, an enterprise network, a virtual private network, and the like. Further, communications may occur over a combination of the various types of above mentioned networks.

The computer 100 has a storage device 104 coupled to a processor 106 by a bus or busses 108. The storage device 104 has a document data 13 and one or more links 115 that provides additional information on the document data. The links 115 contains embedded information referencing one or more external documents viewable using a viewer application and information summarized from different section(s) or portion(s) of the document 13. In one embodiment, the link 115 is associated with the document 13 and is contained within the document 113.

The document 13 may be viewed through a viewer application 114 providing a graphical user interface (GUI). The links are programmatically enforced by the viewer application. In an alternate embodiment, the document 13 may be any type of electronic data.

In one embodiment, the document 113 is a portable document format (PDF). In this embodiment, the storage device 104 has a PDF file 110 that encapsulates the links 115. PDF is a file format utilized to represent a document in a manner independent of the application software, hardware and operating system used to create it. A PDF writer application converts operating system graphics and text commands to PDF operators and embeds them in a PDF file. The PDF files generated are platform independent and may be viewed by a PDF viewer application on any supported platform. Document data 113 in a PDF file 110 contains one or more pages, each page in the document containing a combination of text, graphics and images. Document data 113 may also contain information such as hypertext links, sound and movies. The recipient list 115 contains a list of recipients allowed access to the PDF file 110 document data 113.

The PDF file 110 may be browsed or viewed through a PDF viewer application 114 providing a graphical user interface (GUI). PDF viewer application 114 may be Adobe Acrobat Exchange or Acrobat Reader applications, both made available by Adobe Systems, Inc. of San Jose, Calif.

The file can receive permission attributes into the list 115 of links. The permission attributes identify varying levels of access to data contained in the PDF file 110 as provided to each recipient listed in the list 115. The PDF viewer application 114 accesses the permission attributes embedded in the list of links 115 to determine the level of access permission of a given recipient to a given PDF file 110. The permissions are programmatically enforced by the PDF viewer application 114.

The remainder of the detailed description will be described in reference to the preferred embodiment of the present invention illustrated in FIG. 1. However, it can be appreciated by a person skilled in the art that other equally applicable embodiments may be derived given the detailed description provided herein.

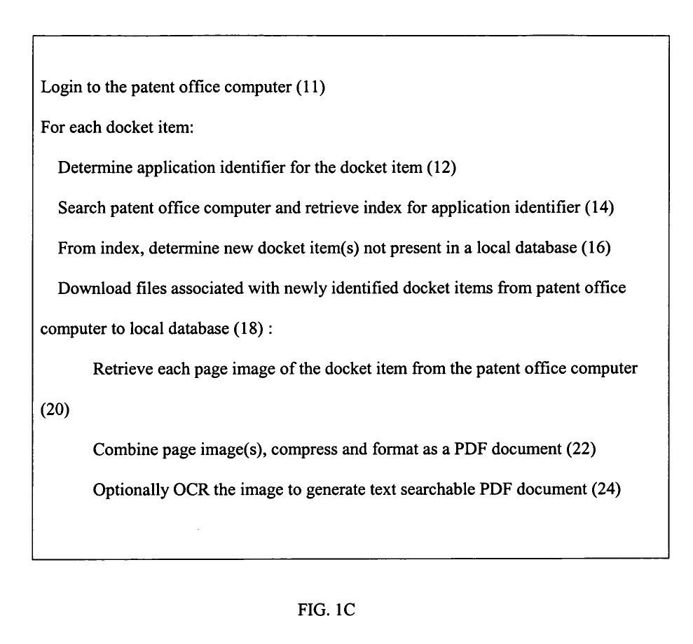

FIG. 2A shows one exemplary process for generating an electronic document in accordance with the invention. The process of FIG. 2A provides an electronic document having first, second and third portions by embedding one or more links in the first portion referencing one or more external documents viewable using a viewer application (180); and embedding one or more links in the third portion referencing information contained in the second portion (190).

In one embodiment, major structure of the document is shown in an outline that can be selected for quick navigation. Thus, a typical document may have an introduction section, a background section, drawings, description of the drawings, among others. The major structures are outlined and the user can easily navigate the document.

In one embodiment, if external documents are referenced, the links referencing external documents can be clicked upon by a user, and a new window opens and the external document is displayed. The link to the external document may be an identifier that can be searched and located from the Internet in one embodiment.

In another embodiment, the links in the third portion can be a link that points back to text in the second portion. When clicked, the user is taken to the appropriate text in the second portion. Alternatively, the links can be shown as PDF comments and/or bookmarks that can be used to navigate to the links.

In another embodiment, a summary of specific items mentioned in the document can be generated. The document may recite a number of items, for example a parts list and due to the numerosity, a summary list for the items may be useful for a reviewer to view. The summary can be placed in the PDF comment section or the PDF bookmark section, among others. When clicked, the user is transported to view the relevant section that mentions, refers, or discusses the item in the summary list.

In yet another embodiment, a navigation bar is provided to allow the user to move to the next item (forward), to go back to the previous item (backward), to go to the beginning (start), to go to the last section (end), or to fast forward and fast reverse, among others. Thus, using the summary list example, the user can use the navigation bar to navigate from the first mentioning of the item to the next mentioning of the item until the end is reached. Similarly, using the reference from the second portion that is mentioned in the third portion, the user can use the navigation bar to navigate the first mentioning of a particular term in the second portion. The user can move to the next mentioning of the term or the previous mentioning of the term.

FIG. 2B shows an exemplary process to generate the document 113 of FIG. 1. First, the process retrieves images of pages of document (202). Next, the process performs optical character recognition (OCR) on the pages of the documents and associates the text with corresponding image location on the page image (204). References to external documents in a first portion of the document are identified (206), and a link to each reference to external documents (208) is generated. With this link, a user can simply click on the title or any suitable mentioning of the external document and the external document will be retrieved and displayed for user review.

Next, the process of FIG. 2B parses text in a third portion for terminology such as text or noun phrases, among others (210). In one embodiment, the process cross-references each discussion of each parsed noun phrase in a second portion of the document (212). The process then links the noun phrase to the cross-referenced discussion (214). In this manner, the process shows consistent and/or inconsistent references to noun phrases in the third portion so that a user can quickly understand potential ambiguities in the document. Items mentioned in the drawings can also be cross-referenced.

In an optional operation, the process of FIG. 2B retrieves a file history of the document (216). The process then cross-references each mentioning of each parsed noun phrase in the file history (218). The noun phrase is linked to each reference in the file history (220). By showing the references to the noun phrases in the file history, the process shows consistent and/or inconsistent references to noun phrases in the third portion so that a user can quickly understand potential ambiguities in the document.

In yet another optional operation, the process of FIG. 2B retrieves each document mentioned in the first portion of the document (222). Each mentioning of each parsed noun phrase or equivalent in the external document is cross-referenced to the corresponding text in the first portion (224). The process then links the noun phrase to each relevant mentioning in the document (226). In this manner, the process of FIG. 2 identifies relevant references to the instant document from the external documents.

In another optional operation, the process performs a database search for additional documents and retrieves each located document (228). The search may locate data over the Internet or may locate data over an Intranet. The process cross-references each mentioning of each parsed noun phrase or equivalent in the located document (230) and links the noun phrase to each relevant mentioning in the located document (232). In this manner, the process of FIG. 2B identifies additional, relevant references to the instant document by performing one or more searches.

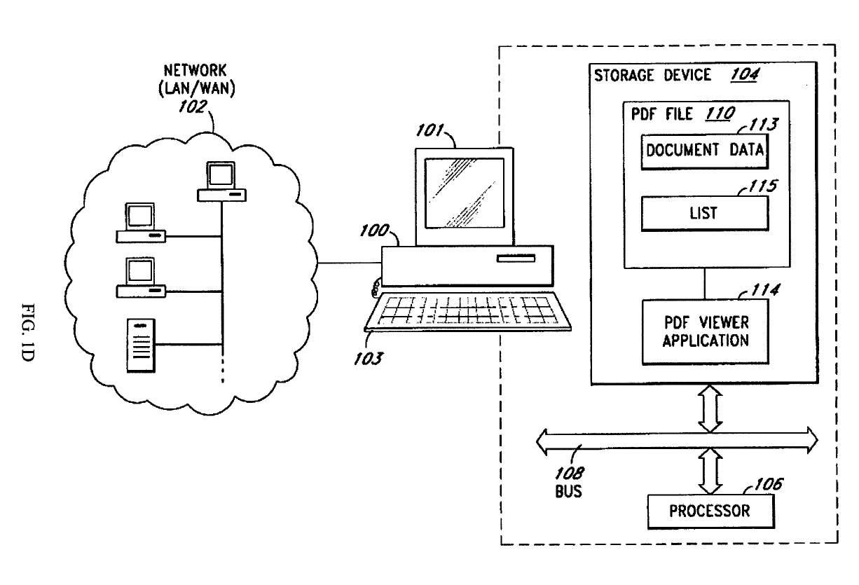

FIG. 3 illustrates an embodiment of the PDF file 110 file structure. A header 300 specifies the version number of the PDF specification to which the PDF file 110 adheres. A body 303 of a PDF file 110 consists of a sequence of indirect objects representing a document. The objects represent components of the PDF document, such as fonts, pages and sampled images. A cross-reference table 305 contains information which permits random access to indirect objects in the PDF file 110, such that the entire PDF file 110 need not be read to locate any particular object. Finally, a trailer 310 enables an application reading a PDF file 110 to quickly find the cross-reference table and to locate special objects.

The PDF file can be generated using a variety of tools such as SDKs from Adobe and Tracker Software. In one embodiment, Tracker Software's PDF-XChange is used. The tool allows the user to append to an existing PDF file (job management is now available & significantly improved); mount multiple source pages on a single output page; output to resolutions of up to 2400 DPI, varied paper sizes (PDF-Xchange supports the 42 most used paper formats+100 forms sizes may be added by the user, DPI now may be not only chosen from the standard list, but also set up manually in the wide range of 50-2400 dpi); manage embedded fonts; work with CJK fonts (PDF-XChange V3 supports fonts containing Unicode symbols for users requiring Chinese, Japanese and Korean (CJK) font compatibility.); design and add watermarks to the output; recognize/create bookmarks automatically; send created PDF documents immediately via e-mail using the internal built-in mailer (SMTP) or call the default system mailer (MAPI)—such as MS Outlook; save files to automated ‘Macro’ based file names and locations; call a viewer or software application after the file is created; create and use profiles to set the environment and setting according to different needs; and use Hot web URL links which are supported.

Next, an exemplary operation of an exemplary embodiment to generate a smart patent PDF file is discussed. In this embodiment, images of patent file wrapper pages are retrieved. The images can be pulled from a proprietary database or can be pulled from various government web sites such as the USPTO (www:uspto.gov), the EPO (www.epo.org), the Korean Patent Office (www.kipo.go.kr), or the JPO (www.jpo.go.jp), or the Chinese State Intellectual Property Office (http://www.sipo.gov.cn) for example. The image of each page is OCRed and the resulting patent text is associated with corresponding image location on the page image.

In one embodiment, the patent images can be downloaded over the Internet. Alternatively, an original can be converted. The PDF Image and Searchable Text Conversion (formerly known as PDF plus hidden text) file contains a bitmapped image of the original, and a hidden layer of searchable text. The conversion process involves: scanning the hardcopy original, performing OCR (Optical Character Recognition) to capture the text of the document, and distilling the two layers into a PDF searchable image file. Though text can be searched, hyperlinks and bookmarks are not fully functional in this format. As with PDF image only, PDF searchable image files are only as legible as the original.

Alternatively, instead of OCRing the text, the patent number can be extracted, a search can be made at the corresponding government patent web site to locate the patent record. For example, if the application has been published, the text is already available in the published patent application database. The patent record is in HTML or XML format, and the various portions of the patent can be separated and indexed. Then, text can be parsed and associated with the PDF document. The association can be position independent or dependent. In position independent embodiment, the location of the text is not aligned with its corresponding image location in the patent image. In position dependent embodiment, the location of the text is aligned with its corresponding image location in the patent image.

The process of can also search for matching claim phrases in external documents listed in a first portion of the patent (known prior art). Text in the known prior art is searched for noun phrases (or equivalent thereof) in the claims. Equivalency can be determined by looking up synonyms in a thesaurus, for example. Other ways of determining equivalency can be used as well. For example, from a corpus set of training patents, if certain words are statistically correlated and are likely to appear with other words, these words are considered to be equivalent and the search terminology can be expanded to include the original words as well as the equivalent words. The process cross-references each discussion of each parsed noun phrase in the external documents and links the words to the cross-referenced discussion. A similar process is performed for the file history of the patent being analyzed. Words that are important in construing the claims based on the file history are then identified for easy review. In addition to the file history, the system can perform a search for other prior art. The search can be carried out using a suitable search engine such as Google, for example, or can be carried out using the patent office search engines, among others. Each pertinent prior art found in the search is retrieved and links from the claim text are made to the newly located prior art.

In one embodiment, the process annotates drawings for user review. This is done by taking the item or part list which has been generated and associating the corresponding item name with the item number. Conversely, if the drawing mentions the item name but not the item number, the drawing can be annotated with the item number. As a result, the review or interpretation of the patent document can be made efficiently by avoiding manual annotation.

In yet another embodiment, the drawings can be annotated with the claim language. Since the user can comprehend images or drawings much faster than text, such annotation of the drawings can enhance review efficiency.

In yet another embodiment, the drawings can be annotated with citations to relevant prior art for ease of identifying novelty. In yet another embodiment, the citations to relevant prior art can be noted along with citations to the claim language.

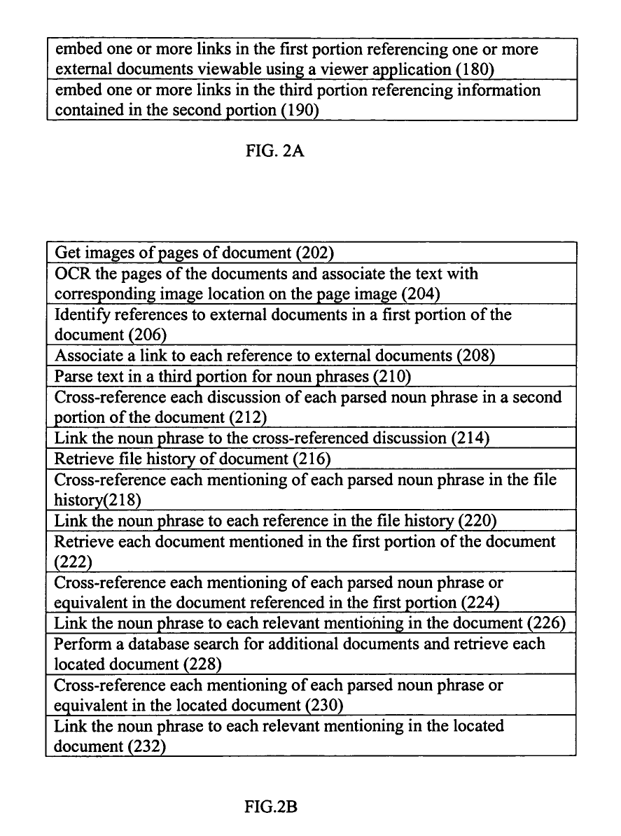

FIG. 4 illustrates an exemplary annotation of the drawings or the claims of a patent document. The process locates citations to the prior art using data from the office action documents in the file history (402); extracts comparisons of the claim language to one or more prior art references (404); and optionally performs a database search, locate relevant prior art; locate description section relevant to the claim and map the prior art to the claim (406) and annotate the document in the drawings or claims, for example (408). The citations to the prior art can be done using data from the file history. In this embodiment, the process extracts comparisons of the claim language to one or more prior art references. Each comparison is noted on the document. Alternatively, the process can perform a database search, locate relevant prior art, and annotate the document appropriately. The database search can be a linguistic search that searches for the terminology, for the concepts, or a combination of both. The linguistic search can also be done using one or more languages such as English, Germany, Japanese, or Chinese, among others.

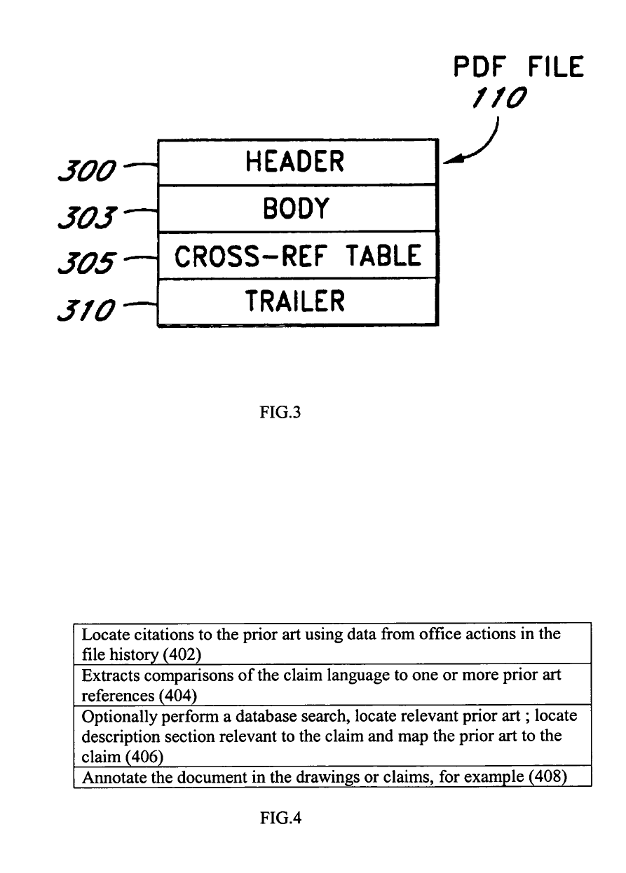

FIG. 5 shows one exemplary environment for IP analysis. In FIG. 5, one or more Technology Developers such as Start-Ups, R&D Labs, Companies, Universities, and Inventors 510 communicate with a server 524. Additionally, Patent Law Firms 512, Licensing Executive Firms 514, IP Service Providers 516, Licensors or Licensees 518, Databases (such as Lexis Nexis or Westlaw) 520, and Patent Offices 522 communicate with the server 524. The server 524 receives requests from one or more clients, and searches its internal databases and/or resources from the patent offices 522, IP providers 516, public/private databases 520 and any other information available to respond to the requests.

The server 524 may communicate with patent offices 140 using electronic mailroom and/or using paper mailroom that uses standard mail (e.g., U.S. Postal Office First Class and Express Mail) that are subsequently scanned. Electronic mailroom may include a suite of programs that interface with programs provided by one or more patent offices. For example, in order to file patent applications electronically through the USPTO, the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom may have the ability to interface to the USPTO's Patent Application Information Retrieval (PAIR) system using appropriate digital certificates. Electronic mailroom may also include other programs to interface with other patent offices. The information received from the patent offices by electronic mailroom may be used to provide docketing services.

In one embodiment, the system automatically maintains a docket of pending cases based on the dates of the documents. The embodiment tracks deadlines such as IDS filing, foreign filing, and Office Action responding, among other. For example, the system generates an IDS reminder date and an IDS due date, both can use a filing date of an application as the base date. The IDS reminder date is calculated by adding two months to the base date and the IDS due date is calculated by adding six months to the filing date, for example. Similarly, a “Foreign Filing” reminder date is computed by adding six months to the base date and the Foreign Filing due date is calculated by adding twelve months to the base date.

For Office Action dates, the base date is the mailing date. The Office Action Reminder date is calculated by adding two months to the base date. The date generated for Office Action Due date is calculated by adding three months to the base date, unless the Office Action is a Restriction in which the deadline is one month from the base date. The date generated for the Office Action “Drop dead” date is calculated by adding six months to the base date. Of course, additional due dates may be defined as desired by users, including “Formal Drawing Submission,” “Office Action,” “Office Action FINAL,” “Ex Parte Quayle Action,” “Notice of Allowance,” “Notice of Appeal”, “Appeal Brief”, “Response to Reply to Appeal Brief”, “First Annuity Payment,” “Second Annuity Payment,” “Third Annuity Payment,” “Fourth Annuity Payment,” and the like. The deadlines can also be specified so as to allow a few spare days ahead of the actual deadlines to give the attorney or applicant spare time to respond. Further, the system can detect if the deadline falls on a weekend or a holiday and automatically move the deadline to the next working day. Moreover, the patent authority triggering event can be specified to allow the docket to handle international cases such as deadlines for PCT, EPO, and JPO applications, among others. The dates are automatically extracted from the file wrapper history index such as the Mail Room Date shown in Col. 1 of FIG. 1A, while the type of document can be determined from the Document Description in Col. 2 of FIG. 1A. Since the dates are automatically identified, the docketing process is accurate and requires few if any human involvement.

The system can work with standard calendaring software such as Microsoft Outlook calendars. The system inserts a calendar entry with case identification information (including a case number and a title, for example), a description of the action to be performed, and the patent office associated with the case. The calendar entry may be color-coded to indicate the degree of urgency of the docketing message. For example, docketing messages that comprise “drop dead dates” may be displayed in red color to emphasize their importance, docketing messages that comprise “reminder dates” and “due dates” may be displayed in various different colors. Docketing messages are automatically generated and electronically communicated to the user. The user can dismiss a calendar entry by deleting or removing the entry using conventional Outlook calendar management techniques. Through Outlook, among other software, the system supports notifying the appropriate users of required tasks, periodically reminding users of task completion deadlines, and tracking time periods associated with both tasks and the time between tasks. The docketing system can also track deadlines arising from the routing of documents to service providers (e.g., informal drawings to a draftsperson for creation of formal drawings) as needed.

In another embodiment, the system automatically generates paperwork associated with an application. For example, the system stores one or more Assignment forms, and upon a deadline to file and record an assignment, the system extracts inventorship information and automatically populates an assignment form with the inventors' names as assignee, their residences, assignee name(s) and their addresses(s). The Assignment, along with a completed (filled) Recordation Cover Sheet such as form PTO1595 are then faxed to the patent office for recording.

In yet another embodiment, the system automatically submits prior art to the patent office. The system copies reference information from a parent or sibling application to related patent applications. The system can enter a docket entry to schedule a review of the references and prepare a citation document.

In another embodiment, the system electronically files documents with the patent office. For example, for the USPTO, the system communicates with EFS, the USPTO's electronic system for submitting patent applications, computer readable format (CRF) biosequence listings, and pre-grant publication submissions. The system can prepare a patent specification in XML format and work with or in lieu of a software package called ePAVE (electronic packaging and validation engine) to assemble the various parts of the application and transmit the application to USPTO over the Internet. A digital certificate is used to secure the transmission of the application to the USPTO. New utility patent applications, Provisional applications, Biosequence listings for applications previously filed in paper, Pre-grant publication resubmissions for previously filed applications, where the applicant wants an amended, redacted, voluntary, or republication specification to be published rather than the application as originally filed, Subsequent bio-sequence submissions, Multiple assignments, Electronic Information Disclosure Statements (eIDS), Design applications, New plant applications, Corrected or revised patent application republications, Reissue applications, International Patent Cooperation Treaty (PCT) applications, and Reexamination requests, among others.

In yet another embodiment, the system inserts checklists to ensure proper drafting criteria are met and creates tasks with associated dates such as deadlines for responses, and other similar tasks that are common to many applications and have predictable elements. For example, a client may request that a certain checklist of drafting criteria be completed before each filing, and the checklist may be implemented as a task associated with each of the client's matters. Also, creation of docket dates and tasks associated with those dates in a system such as the present invention may be automatically calculated and created by a template, ensuring proper application of applicable rules. Many other such examples of tasks common to many applications with predictable elements exist, and all are within the scope of the template function as implemented in the example of the system described herein.

In another embodiment for downloading published patent applications, the system can receive as input a patent application serial number in the form of ______ which is the number used to correspond with the USPTO rather than the 200______ designation for published applications. The embodiment automatically converts the patent application serial number into the published application number for retrieval or downloading purposes. A mapping operation is performed to translate the serial number into the published application number. First the process accepts the application serial number in a format Series Code/application Serial Number (APN). The Series Code is a two digit identifier as follows:

Series Codes:
2—Earlier than Jan. 1, 1948
3—Jan. 1, 1948-Dec. 31, 1959
4—Jan. 1, 1960-Dec. 31, 1969
5—Jan. 1, 1970-Dec. 31, 1978
6—Jan. 1, 1979-Dec. 31, 1986
7—Jan. 1, 1987-Dec. 31, 1992
8—Jan. 1, 1993-Dec. 31, 1997
9—Jan. 1, 1998-Dec. 4, 2001 (Approx.)
10—Dec. 4, 2001-Current
29—Design applications filed beginning in January 1993

The application Serial Number (APN) field contains the identification number assigned by the US Patent and Trademark Office to applications which have received a filing date. In one embodiment, the APN is the last six digits of the application serial number. The system then performs a search with APN=the last six digits. From the result of the search, the system retrieves each search result and searches for a matching series code in the text of a particular application. For example: searching APN=000001 as of early 2004 locates four documents, each having been assigned serial number 1 within different series codes. Since the search specified only the last 6 digits, there may be up to 10 series with the same 6 digit identifier. The system then looks into the text of each application that ends with 000001 with the correct Series Code. This embodiment allows the user to retrieve a published application using the application serial number that the PTO corresponds with rather than the 200______ designation for published applications. Thus, in this example, entering 10/000001 in the document designator input box will map into the following search command at the USPTO search site APN/000001. The result returned is:
20030035113 Quadrature phase shift interferometer with unwrapping of phase

To confirm that this application is 10/000001, the text for the application is retrieved and a text search for “Series Code:” reveals that the series code is 10, confirming that the application Ser. No. 10/000001 is the same as Published application 20030035113 and the image of the published application can be retrieved.

In another embodiment, instead of entering a published patent application number to retrieve a PDF of the document, the user enters an assignee name or a keyword and the system retrieves all copies of patents or published patent applications matching the name or keyword. Pseudo code for this embodiment is as follows:
Receive assignee search term in input box that normally receives a patent number or patent application number
Search the patent office for all patents whose assignee matches the assignee search term
For each matching patent, download images for the patent, combine and put in a single document (such as PDF document).
Search the patent office for all patent applications whose assignee matches the assignee search term
For each matching patent, download images for the patent application, combine and put in a single document (such as PDF document).

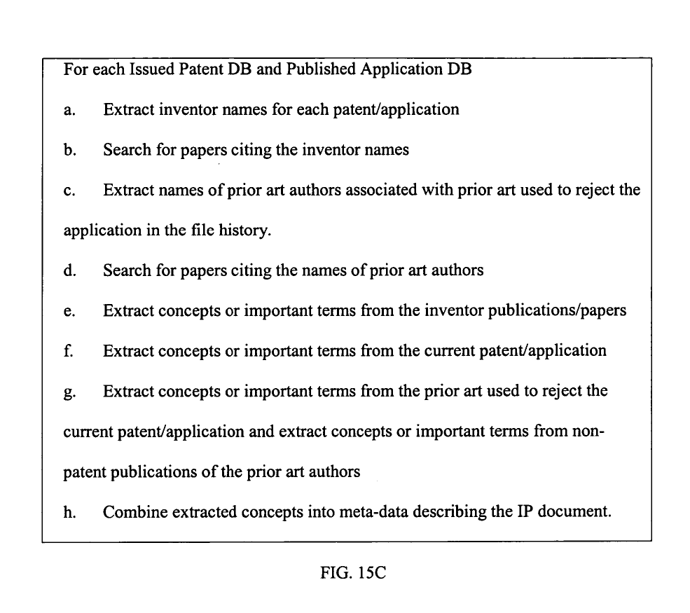

The server 524 can also include a search engine. In one embodiment, the search engine searches electronic copies of patents from various authorities including the USPTO, the EPO, the JPO, the SIPO, and KPO, among others. The electronic copies of patents are stored in one or more local databases. More details on the search engine are disclosed in FIG. 14 below.

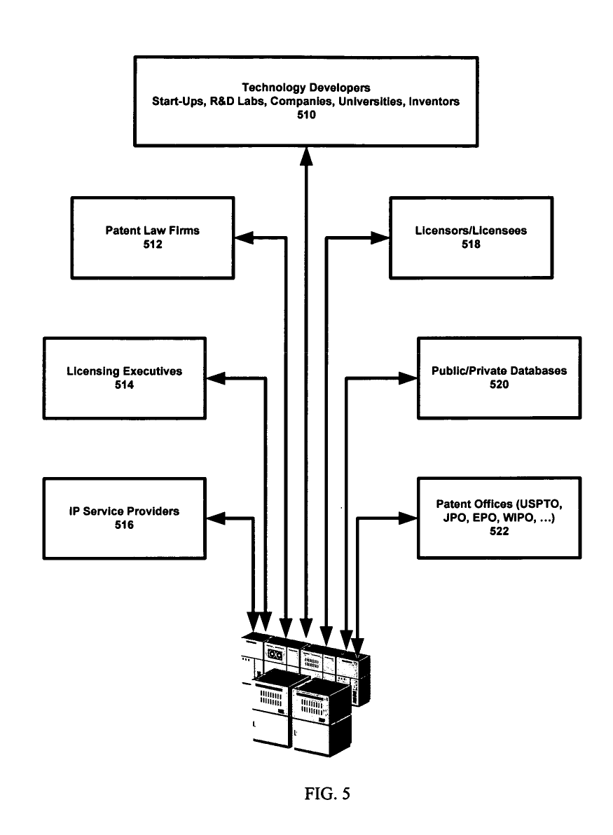

The requests may include requests for copies of a particular patent. In response, the processes of FIGS. 1-4 may be used to satisfy the request. When there are many users that are likely to make requests for the same patent document, caching can be used to minimize network burden on the source. FIG. 6 shows one embodiment for handling patent requests from a client machine. The process receives a list of patents to be downloaded (602) as specified at the client machine. The process checks databases on the remote server to see if the requested patent is already cached or stored at the remote server (604). If so, the process fetches the database and provides the copy as the response to the request (618). If the patent is not cached or stored in the server already, the client machine starts a download process for the patent from one of sources 520 or 522 as appropriate. Operations 606-616 occur at the client machine. The process can download the entire patent at a time, or, since network failures may occur for large files, the process downloads each page of the patent separately to minimize retransmission due to network failure (606). In one embodiment, OCR processing is applied to the image to extract text from the image of the patent, and the location of each text is mapped to the image (608). In this manner, text searchable patent document can be created. Next, the patent is annotated to enhance human as well as machine interpretation (610), one embodiment is shown in FIG. 4. The resulting document is compressed and optionally encrypted (612). Since the document is not already on the server, the document is sent back to the server to be cached (614) to satisfy another request for the patent. Finally, the process provides the document to the user in satisfaction of the request (616).

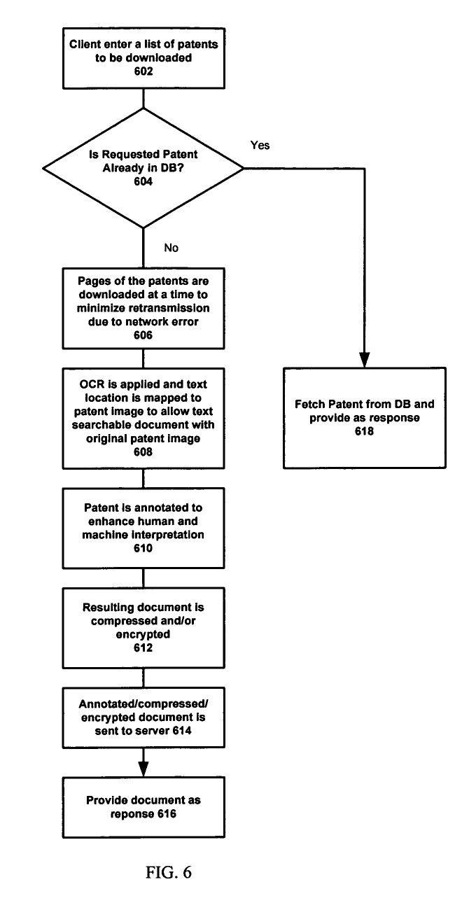

FIG. 7 shows one embodiment of a process to map intellectual property. First, a user enters at a local machine one or more search queries to indicate the area to be mapped (702). For example, the user may enter “car” to indicate that the auto industry IP portfolio is to be mapped. The user can also enter Chrysler to indicate that Chrysler's IP portfolio is to be analyzed. The process checks with the remote server to see if an identical search request has been done before (704). If so, the result response to the search query is provided as a response (718). If not, operations 706-716 are performed by the client machine. First, the client machine issues one or more search requests directed at one or more databases and mine data relating to the search query (706). For example, the client may search a patent office database and locate patents responsive to the search query. A crawler can be sent to search and retrieve patents in the field of interest (708). The process can perform secondary or additional searches based on the initial search (710).

Next, network analysis is performed on the search result in one embodiment (712). Network analysis can generate sociograms (network diagrams) to visualize the networks being analyzed. One technique to draft a sociogram is to construct it around the circumference of a circle. The circle helps organize the data, but the order in which the points is determined only by an attempt to keep the number of lines connecting the various points to a minimum. Typically, a trial-and-error drafting process is used until an aesthetically pleasing result is achieved. While such a process can make the structure of relations clearer, the relations between the sociogram's points reflect no specific mathematical properties. The points are arranged arbitrarily and the distances between them are meaningless. A number of techniques (e.g., metric and non-metric multidimensional scaling, correspondence analysis, spring-embedded algorithms, etc.) that mathematically represent the points in space can be used.

The analysis is stored in a document, which can be compressed and optionally encrypted (714). Since the document is not already on the server, the document is sent back to the server to be cached (716) to satisfy another request for the patent. Finally, the process provides the document to the user in satisfaction of the request (718).

Pseudo-code for one exemplary IP mapping system is as follows:
1. Receive two keyword boxes (K1 and K2) and assignee table for list of Y competitors in a Yx1 column
2. Build search command for all patents with keywords K1 and K2 and assignees (Y1 or Y2 or . . . or Yn)
3. Run search command in Issued Patent DB and Published Application DB
4. Allow the user to review search result and revise search if needed
5. Download all text for all search results and parse into sections
6. Extract cited prior art patents for all search results and create a common unique list of prior art patents
7. Identify patents not in the search results and update list of assignee for these patents to YS1.
8. Run search in Issued and Published Application DBs with command: keywords K1 and K2 and assignees YS1 or YS2 or . . . YSn and downloaded/parsed into sections
9. For each patent, create spring relationship among patents based on number of citation of patent prior art. Generate spring mass diagram. Allow user to play with the spring mass. For each patent, he can view each section of the patent, see PDF or TIFF versions.
10. Clusterize according to word similarity
11. Provide graphics wizard to easily generate a view of IP space for display, plot on a large format plotter or 3D virtualization.

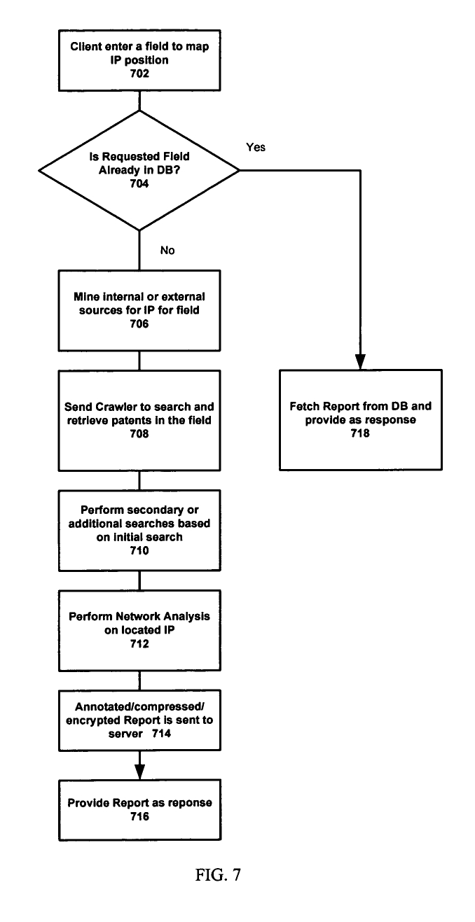

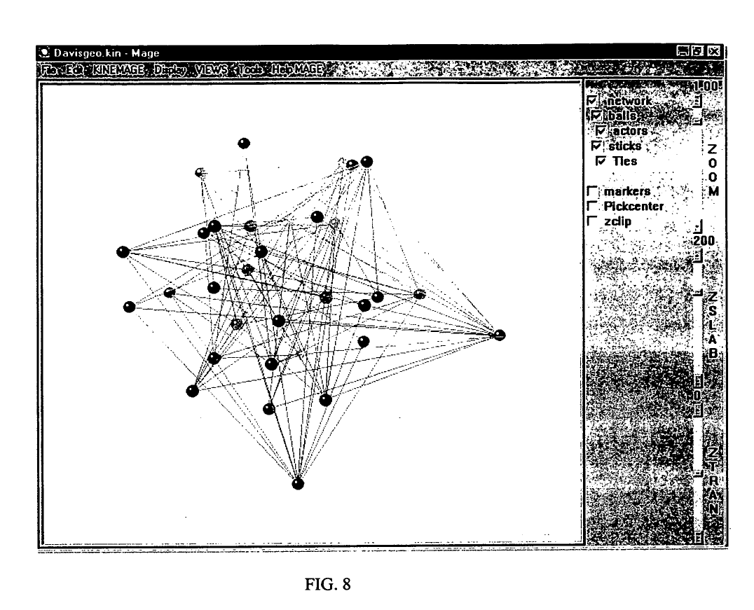

FIGS. 8-9 show exemplary mappings of IPs. In the exemplary display of FIG. 8, each patent is represented as a sphere. In FIG. 9, the patents are arranged as hyperbolic trees.

In the embodiment of FIG. 8, the rendering tool is MAGE. The user may maneuver the view using three control bars: “ZOOM,” “ZSLAB” and “ZTRAN.” The “ZOOM” bar allows users to “move” the object closer or farther away. The “ZSLAB” bar controls contrast while the “ZTRAN” bar controls brightness. Also along the right side of the screen are a series of “switches” that allow users to turn particular features (e.g., nodes, labels, ties) of the image off or on and thereby call attention to various structural properties. Users can rotate the image. Such rotation can potentially uncover structural regularities that may not be readily observable at first glance. The colors of the nodes, ties and labels can be changed as well.

In another embodiment, the patent mapping can also be a virtual 3D environment where the user is placed in a virtual environment to enable the user to manipulate and explore IP relationships. In yet other embodiments, the patent mapping can also be a haptic interface, that is, interface which provides a touch-sensitive link between a physical haptic device and an electronic environment. With a haptic interface, a user can obtain touch sensations of surface texture and rigidity of electronically generated virtual objects, such as may be created by a computer-aided design (CAD) system. Alternatively, the user may be able to sense forces as well as experience force feedback from haptic interaction with an electronically generated environment. A haptic interface system typically includes a combination of computer software and hardware. The software component is capable of computing reaction forces as a result of forces applied by a user “touching” an electronic object. The hardware component is a haptic device that delivers and receives applied and reaction forces, respectively. Existing haptic devices include, for example, joysticks (such as are available from Immersion Human Interface Corporation, San Jose, Calif.; further information is available at www.immerse.com, the disclosure of which is incorporated herein by reference for all purposes), one-point probes (such as a stylus or “spacepen”) (such as the PHANToM™ product available from SensAble Technologies, Inc., Cambridge, Mass.; further information is available at www.sensable.com, the disclosure of which is incorporated herein by reference for all purposes) and haptic gloves equipped with electronic sensors and actuators (such as the CyberTouch product available from Virtual Technologies, Inc., Palo Alto, Calif.; further information available at www.virtex.com, incorporated herein by reference for all purposes).

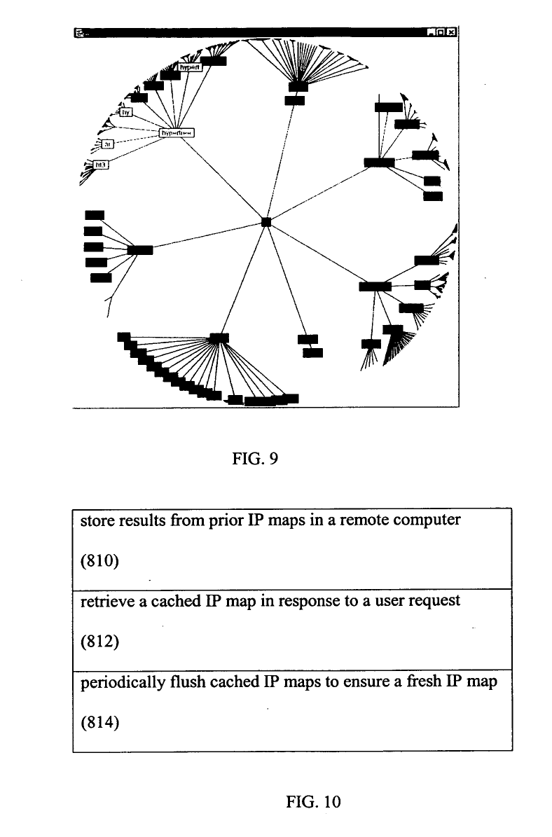

FIG. 10 shows an exemplary process for caching IP documents on the server. The process stores results from prior IP maps in a remote computer (810). It also retrieves a cached IP map in response to a user request if the patent number matches one of the cached IP documents (812). The process also periodically flushes cached IP maps to ensure a fresh IP map (814).

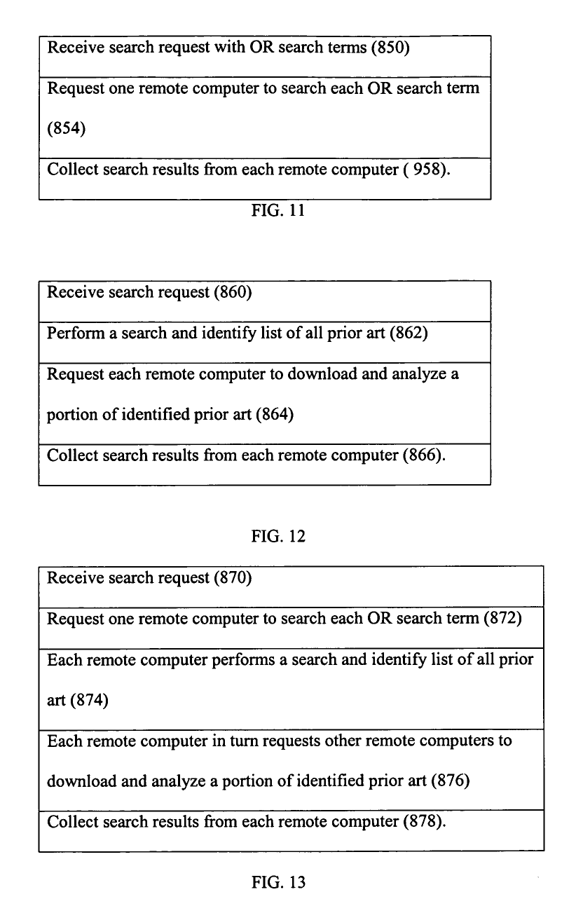

FIG. 11 shows an exemplary process for distributed mapping of IPs. The process receives search request with OR search terms (850); requests one remote computer to search each OR search term (854) and collects search results from each remote computer (958).

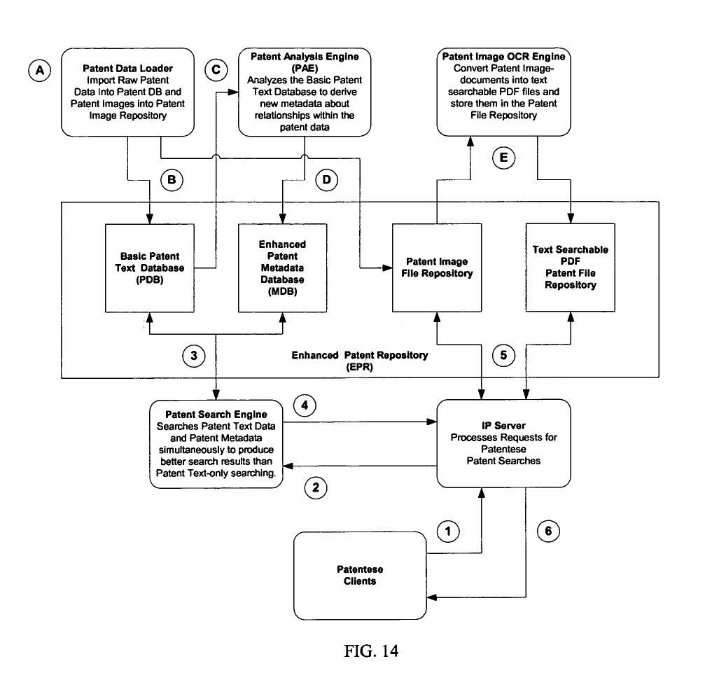

FIG. 12 shows a second embodiment of distributed mapping. The process receives a search request (860). It performs a search and identify list of all prior art (862). The process then requests each remote computer to download and analyze a portion of identified prior art (864). The process collects search results from each remote computer (866).

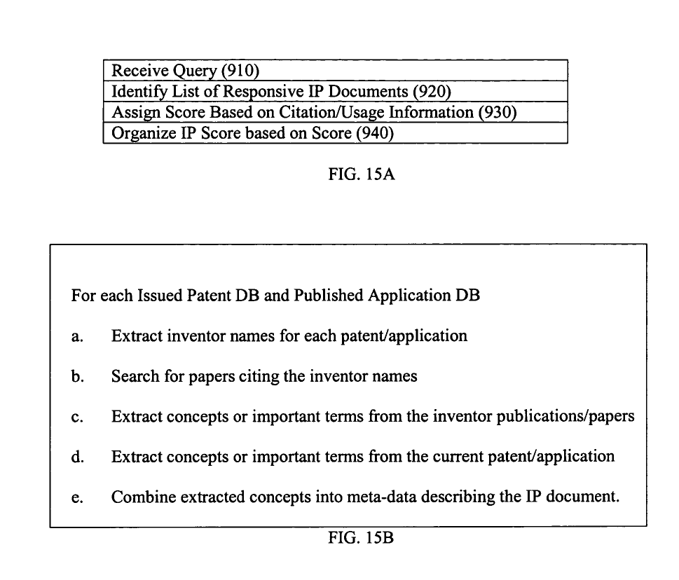

FIG. 13 shows a third embodiment of distributed mapping. The process receives search request (870); requests one remote computer to search each OR search term (872). Each remote computer performs a search and identify list of all prior art (874). Each remote computer in turn requests other remote computers to download and analyze a portion of identified prior art (876). The process then collects search results from each remote computer (878).

One type of network can be associative networks. The associative networks used in the system are Pathfinder networks (PfNets). The Pathfinder algorithm was developed to model semantic memory in humans and to provide a paradigm for scaling psychological similarity data. A number of psychological and design studies have compared PFNETs with other scaling techniques and found that they provide a useful tool for revealing conceptual structure. The PfNet representations underlying the system's network displays are minimum cost networks derived from measures of term and document associations. The network of documents is based on interdocument similarity, as measured by co-occurrence of keywords between document pairs. For the network of terms, or associative term thesaurus, the visual representation of the user's query, and single document representations the associations are derived from text with association measured by keyword co-occurrence and lexical distance within documents. PfNets can be conceptualized as path length limited minimum cost networks. Algorithms to derive minimum cost spanning trees (MCSTs) have only the constraints that the network is connected and cost, as measured by the sum of link weights, is a minimum. For PfNets, an additional constraint is added: Not only must the graph be connected and minimum cost, but also the longest path length to connect node pairs, as measured by number of links, is less than some criterion. To derive a PfNet direct distances between each pair of nodes are compared with indirect distances, and a direct link between two nodes is included in the PfNet unless the data contain a shorter path satisfying the constraint of maximum path length.

In constructing a PfNet two parameters are incorporated: r determines path weight according to the Minkowski r-metric and q specifies the maximum number of edges considered in finding a minimum cost path between entities. As either parameter is manipulated, edges in a less complex network form a subset of the edges in a more complex network. Thus, the algorithm generates two families of networks, controlled by r and q. The least complex network is obtained with r=infinity and q=n-1, where n is the total number of nodes in the network. The containment property has in practice provided a particularly useful technique for systematically varying network density to provide both relatively sparse networks (the union of MCSTs with r=infinity and q=n-1) for global navigation, as well as more dense networks for local inspection.

In addition to the query and document term displays the user can access two other visually displayed network structures: an associative thesaurus of terms, and a network of documents. The associative thesaurus is based on a PfNET of all terms in the database. The distances for deriving this network are found using the same weighted co-occurrence measure used in assigning term distances in documents and queries. All documents are analyzed and an additional value is added to term pair similarity is for terms co-occurring in the same document. For the network of documents, distances between documents are calculated using the same matching algorithm used to assess query-document similarity. Network similarity is calculated by combining the number of commons terms with a measure of structural similarity for these common terms.

In one embodiment, overview diagrams are used to supply a user with (1) knowledge about the organization of the complete network, (2) a means for navigating the network, and (3) orientation within the complete network. In overview diagrams a small number of nodes, selected to provide information about the organization of the complete network, are displayed to the user. Additionally, the nodes typically provide entry points for traversing the network. These nodes provide orientation by serving as landmarks to assist the user in knowing what part of the network is currently being viewed.

Alternatively, techniques such as hyperbolic trees can be used to visualize relationship among patents. The patent documents can be represented as trees, including structured documents, directories, and some kinds of hypertext (those that have no cyclic links). A tree is drawn as large as it needs to be and then render an image that is controlled with scroll bars. This process has the problem that the user is prevented from seeing the overall structure and must keep most of a large space in memory rather than in view. Trees are useful for representing large collections of documents, but single documents are also amenable to tree representations if the underlying structure of the document is hierarchical. There is a movement toward representing text structurally. SGML is a prime example of an effort to systematize document structure. Editors that are used to create SGML-compliant text maintain document structure as trees. In SGML trees, the content of a document resides in the leaf nodes of the tree.

Many views of documents can be thought of as networks. Queries, semantic networks, associative thesaurus and hypertexts can all be represented as networks. Multidimensional data, discussed above, differ qualitatively from network data in that the latter have dependencies among the parts. Multidimensional scaling methods tend to drive concepts apart, i.e., to find orthogonal dimensions, while networks assume dependencies among the concepts being manipulated.

Network displays can represent more general and more complicated structures than hierarchical displays. The complexity of the information spaces when expressed as networks can be difficult for users to comprehend. A major issue then is how to simplify such displays without losing critical information. One method for reducing complexity is to reduce the dimensionality of the space. Latent semantic indexing (LSI) is a method can be applied to reducing dimensionality.

Hyperbolic graph layout uses context and focus technique to represent and manipulate large tree hierarchies on limited screen size. Hyperbolic trees are based on Poincare's model of the (hyperbolic) non-Euclidean plane. The hyperbolic layout employs a Radical Layout: Conventionally, trees are displayed on an Euclidean plane with the root at the top and children below their parents and connected to their parents with edges. The hyperbolic layout uses a radical layout. The root is placed at the center while the children are placed at an outer ring to their parents. The circumference jointly increases with the radius and more space becomes available for the growing numbers of intermediate and leaf nodes. The hyperbolic layout also uses a Distortion Technique where the hyperbolic layout uses a nonlinear (distortion) technique to accommodate focus and context for a large number of nodes. To ensure that nodes do not overlap each other, hyperbolic layout algorithms assign an open angle for each node. All children of a node are laid out in this open angle. Transformations are provided to allow fluent node repositioning. User can click on a node to move it to the center or to grab and reposition a single node. While traditional methods such as paging (divides data in to several pages and display one page at a time) zooming, or panning show only part of the information at a certain granularity, hyperbolic trees show detail and context at once.

Although the foregoing relates to an issued patent document, the same can be applied to pending applications as well. Also, the analysis process and embedding of information are applicable to a number of patent offices including the USPTO, EPO, JPO, and KIPO, among others. Further, although PDF is mentioned as one embodiment, other document formats are contemplated. Examples of such document formats include Microsoft's XDoc, HTML documents, XML documents, TIFF documents, JPEG documents, and multimedia documents, among others. XDocs (InfoPath) is Microsoft's new XML-based forms and document solution. XDocs is optimized for the Microsoft Office System, picture it as an ecosystem that represents a combination of familiar and easy-to-use programs, servers and services that are intended to help information workers address a broader array of business challenges. It encompasses the core Microsoft Office client applications, as well as FrontPage 2003, Visio 2003, Project 2003 and Publisher 2003, as well as new desktop applications, InfoPath 2003 and OneNote 2003. With the addition of servers, such as SharePoint Portal Server 2003, Project Server 2003 and the Live Communications Server 2003, users will be able to take advantage of deeper collaboration capabilities and communication tools like live chats within familiar productivity applications right from their PCs.

In one embodiment, the system provides a search engine optimized for patent prior art search. The engine is first trained with training data and after optimization based on training, is applied to perform searches in real time. The engine can use any analytic methods such as Term clustering, Latent Semantic Indexing, Naive Bayesian, Decision Trees, Decision Rules, Regression Modeling, Perceptron Method, Rocchio Method, Neural Networks, Example-based methods, Support Vector Machine, Classifier Committees, and Boosting, among others.

In one embodiment, the system is trained in an off-line mode using local and remote training data. The training corpus is the US Patent database, the EPO database, and abstract translations of the JPO database. The patent databases are local in one embodiment due to the volume of information. The patent databases are indexed for quick searching. Additionally, software robots survey the Web and add to the databases by retrieving and indexing web documents. When a user enter a query at a search engine website, the query input is checked against the search engine's keyword indices. The best matches are then returned as hits.

In one embodiment, the search engine performs text query and retrieval using keywords. Essentially, this means that search engines pull out and index words that are believed to be significant. Full-text indexing systems generally pick up every word in the text except commonly occurring stop words such as “a,” “an,” “the,” “is,” “and,” “or,” and “www.” Some of the search engines discriminate upper case from lower case; others store all words without reference to capitalization. However, keyword searches have a tough time distinguishing between words that are spelled the same way, but mean something different (i.e. hard cider, a hard stone, a hard exam, and the hard drive on your computer). This can result in hits that are completely irrelevant to the query.

Search engines also cannot return hits on keywords that mean the same, but are not actually entered in your query. A query on heart disease would not return a document that used the word “cardiac” instead of “heart.” Excite used to be the best-known general-purpose search engine site on the Web that relies on concept-based searching. Unlike keyword search systems, concept-based search systems try to determine what you mean, not just what you say. In the best circumstances, a concept-based search returns hits on documents that are “about” the subject/theme you're exploring, even if the words in the document don't precisely match the words you enter into the query. There are various methods of building clustering systems, some of which are highly complex, relying on sophisticated linguistic and artificial intelligence theory that we won't even attempt to go into here. In one embodiment, software determines meaning by calculating the frequency with which certain important words appear. When several words or phrases that are tagged to signal a particular concept appear close to each other in a text, the search engine concludes, by statistical analysis, that the piece is “about” a certain subject. For example, the word heart, when used in the medical/health context, would be likely to appear with such words as coronary, artery, lung, stroke, cholesterol, pump, blood, attack, and arteriosclerosis. If the word heart appears in a document with others words such as flowers, candy, love, passion, and valentine, a very different context is established, and a concept-oriented search engine returns hits on the subject of romance.

The search engines can return results with confidence or relevancy rankings. In other words, they list the hits according to how closely they think the results match the query. In one embodiement, the search engines consider both the frequency and the positioning of keywords to determine relevancy, reasoning that if the keywords appear early in the document, or in the headers, this increases the likelihood that the document is on target. For example, one method is to rank hits according to how many times your keywords appear and in which fields they appear (i.e., in headers, titles or plain text). Another method is to determine which documents are most frequently linked to other documents on the Web. The reasoning here is that if patent applicants or examiners consider certain patents important, the user should be aware of the information.

The search engines can index Web documents by the meta tags in the documents' HTML (at the beginning of the document in the so-called “head” tag). What this means is that the Web page author can have some influence over which keywords are used to index the document, and even in the description of the document that appears when it comes up as a search engine hit.

FIG. 14 illustrates an illustrative Patent Search Process. In (1) Patentese client will issue a patent search request to the IP Server. In (2) the IP Server will process the request and invoke the Patent Search Engine to search for the desired patents. In (3) the Patent Search engine will perform an enhanced search of the dataset comprising both the Basic Patent Text Database and the Enhanced Patent Metadata Database. There can be two operations:
a. The Basic Patent Database (PDB) consists of the available text information contained within the patent document. This includes the title, abstract, claims, etc.
b. The Enhanced Patent Metadata Database (MBD) contains additional information/metadata about the patents and their relationships to other patents. This metadata is produced by the Patent Analysis Engine which operates in the background, continuously updating the information in the MDB.

In (4) the Patent Search Engine will return to the IP Server a search result comprising of a set of patent numbers and summary information that correspond to the desired search. In (5) the IP Server will identify and cache the set of Patent Documents from the Patent Image File Repository and the Text Searchable PDF Patent File Repository that correspond to the search result. These patent documents will consist of Text Searchable PDF Patent Files and/or Patent Image Files depending on availability. Patent Documents will then be available for additional download requests from the Patentese Client. In (6) the IP Server will return the Patent Search Result set to the Patentese Client. After examining the Patent Search Result set, the Patentese Client may optionally request the download of one or more Patent Documents as needed.

A. Raw Patent Data will be provided from a database that has
a. XML-based Patent Text
b. TIFF Patent Document Images

B. The Patent Data Loader will import raw Patent Text Data into the Basic Patent Text Database (PDB) and Patent Image Documents into the Patent Image File Repository.

C. The Patent Analysis Engine will perform multiple analysis operations to process sets of data from the PDB to generate new metadata describing the patents and their relationships to other patents. The PAE consists of multiple independent agents that each uses a different algorithm/methodology to classify the patent data and extract useful metadata.

The Patent Analysis Engine will use analytic methods such as;
i. Term clustering
ii. Latent Semantic Indexing
iii. Naive Bayesian
iv. Decision Trees
v. Decision Rules
vi. Regression Modeling
vii. Perceptron Method
viii. Rocchio Method
ix. Neural Networks
x. Example-based methods
xi. Support Vector Machine
xii. Classifier Committees
xiii. Boosting

D. The Patent Analysis Engine will tag the new metadata with the appropriate patent ID and store it in the Enhanced Patent Metadata Database (MDB).

E. The Patent Image OCR Engine will process the Patent Image Documents and use an Optical Character Recognition process to convert them into Text Searchable PDF Patent Files. Once converted, the new documents will be stored in the Text Searchable PDF Patent File Repository.

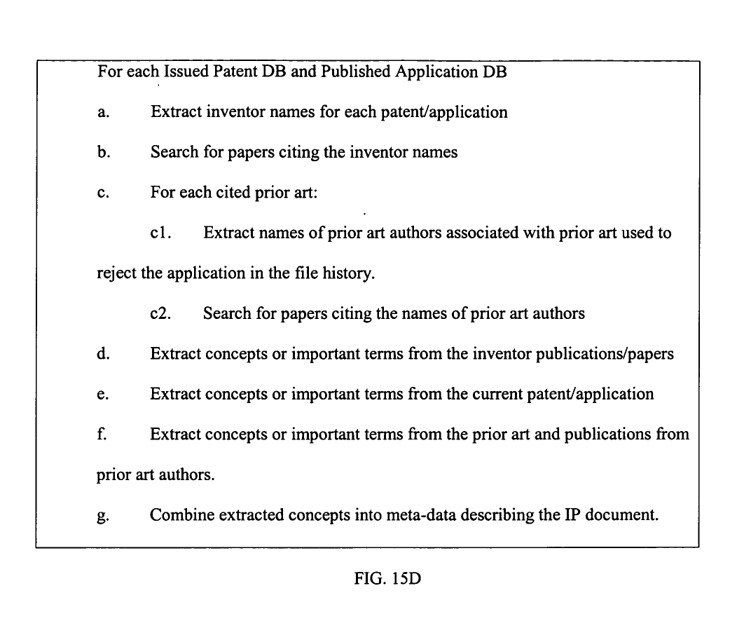

FIG. 15A illustrates a flow diagram, consistent with the invention, for organizing IP documents such as patents based on usage information. At stage 910, a search query is received by a search engine. The query may contain text, audio, video, or graphical information. At stage 920, the search engine identifies a list of documents that are responsive (or relevant) to the search query. This identification of responsive documents may be performed in a variety of ways, consistent with the invention, including conventional ways such as comparing the search query to the content of the document. Once this set of responsive documents has been determined, it is necessary to organize the documents in some manner. Consistent with the invention, this may be achieved by employing usage statistics, in whole or in part. As shown at stage 930, scores are assigned to each document based on the usage information. The scores may be absolute in value or relative to the scores for other documents. This process of assigning scores, which may occur before or after the set of responsive documents is identified, can be based on a variety of usage information. In a preferred implementation, the usage information comprises both unique visitor information and frequency of visit information. The usage information may be maintained at a client computer and transmitted to the search engine. The location of the usage information is not critical, however, and it could also be maintained in other ways. For example, the usage information may be maintained at servers, which forward the information to search engine; or the usage information may be maintained at the server if it provides access to the documents (e.g., as a web proxy). At stage 940, the responsive documents are organized based on the assigned scores. The documents may be organized based entirely on the scores derived from usage statistics. Alternatively, they may be organized based on the assigned scores in combination with other factors. For example, the documents may be organized based on the assigned scores combined with link information and/or query information. Link information involves the relationships between linked documents, and an example of the use of such link information is described in U.S. application Ser. No. 20020123988, the content of which is incorporated by reference. Query information involves the information provided as part of the search query, which may be used in a variety of ways to determine the relevance of a document. Other information, such as the length of the path of a document, could also be used.

In one implementation, documents are organized based on a total score that represents the product of a usage score and a standard query-term-based score (“IR score”). In particular, the total score equals the square root of the IR score multiplied by the usage score. The usage score, in turn, equals a frequency of visit score multiplied by a unique user score multiplied by a path length score.

In one embodiment, the frequency of visit score equals log 2*(1+log(VF)/log(MAXVF). VF is the number of times that the document was visited (or accessed) in one month, and MAXVF is set to 2000. A small value is used when VF is unknown. If the unique user is less than 10, it equals 0.5*UU/10; otherwise, it equals 0.5*(1+UU/MAXUU). UU is the number of unique hosts/IPs that access the document in one month, and MAXUU is set to 400. A small value is used when UU is unknown. The path length score equals log(K-PL)/log(K). PL is the number of ‘/’ characters in the document's path, and K is set to 20.

The computation of the frequency of visits begins with a raw count, which could be an absolute or relative number corresponding to the visit frequency for the document. For example, the raw count may represent the total number of times that a document has been visited. Alternatively, the raw count may represent the number of times that a document has been visited in a given period of time (e.g., 100 visits over the past week), the change in the number of times that a documents has been visited in a given period of time (e.g., 20% increase during this week compared to the last week), or any number of different ways to measure how frequently a document has been visited. In one implementation, this raw count is used as the refined visit frequency. In other implementations, the raw count may be processed using any of a variety of techniques to develop a refined visit frequency. The raw count may be filtered to remove certain visits. For example, one may wish to remove visits by automated agents or by those affiliated with the document at issue, since such visits may be deemed to not represent objective usage. This filtered count may then be used to calculate the refined visit frequency. Instead of, or in addition to, filtering the raw count, the raw count may be weighted based on the nature of the visit. For example, one may wish to assign a weighting factor to a visit based on the geographic source for the visit. Any other type of information that can be derived about the nature of the visit (e.g., the browser being used, information concerning the user, etc.) could also be used to weight the visit. This weighted visit frequency may then be used as the refined visit frequency.

As with the techniques for computing visit frequency, the computation of user count begins with a raw count, which could be an absolute or relative number corresponding to the number of users who have visited the document. Alternatively, the raw count may represent the number of users that have visited a document in a given period of time (e.g., 30 users over the past week), the change in the number of users that have visited the document in a given period of time (e.g., 20% increase during this week compared to the last week), or any number of different ways to measure how many users have visited a document. The identification of the users may be achieved based on the user's Internet Protocol (IP) address, their hostname, cookie information, or other user or machine identification information. In one implementation, this raw count is used as the refined number of users. In other implementations, the raw count may be processed using any of a variety of techniques to develop a refined user count. For example, the raw count may be filtered to remove certain users. For example, one may wish to remove users identified as automated agents or as users affiliated with the document at issue, since such users may be deemed to not provide objective information about the value of the document. This filtered count may then be used to calculate the refined user count. Instead of, or in addition to, filtering the raw count, the raw count may be weighted based on the nature of the user. For example, one may wish to assign a weighting factor to a visit based on the geographic source for the visit (e.g., counting a user from Germany as twice as important as a user from Antarctica). Any other type of information that can be derived about the nature of the user (e.g., browsing history, bookmarked items, etc.) could also be used to weight the user. This weighted user information may then be used as the refined user count.

Although only a few techniques for computing the visit frequency and the number of users are described above, those skilled in the art will recognize that there exist other ways for computing the visit frequency or the number of users, consistent with the invention. Further, the above described types of usage information are examples used to organize documents, those skilled in the art will recognize that there exist other such type of information and techniques consistent with the invention. Further, other techniques consistent with the information may be used to associate usage information with a document. For example, rather than maintaining usage information for each document, one could maintain usage information on a site-by-site basis. This site usage information could then be associated with some or all of the documents within that site.

FIG. 15B shows another embodiment for IP document indexing and searching. This embodiment trains the corpus with both patent and non-patent documents. In one implementation, meta-tags are generated for each patent document. Based on the patent document meta-tags (such as inventorship or cited prior art or claim wordings), the system searches non-patent publications for papers written by the inventors that have been published. The composite information is tagged and important parts of both patent and non-patent documents are tagged as meta-data to improve searching.

Pseudo-code for the process to index IP documents in FIG. 15B is as follows:

For each Issued Patent DB and Published Application DB
a. Extract inventor names for each patent/application
b. Search for papers citing the inventor names
c. Extract concepts or important terms from the inventor publications/papers
d. Extract concepts or important terms from the current patent/application
e. Combine extracted concepts into meta-data describing the IP document.

FIG. 15C shows another embodiment for IP document indexing and searching. This embodiment trains the corpus with both patent and non-patent documents. In one implementation, meta-tags are generated for each patent document. Based on the patent document meta-tags (such as inventorship or cited prior art or claim wordings), the system searches non-patent publications for papers written by the inventors that have been published. In addition, the system searches an electronic copy of the file history to identify prior art used to reject the patent and extracts concepts or important terms in the prior art and supplements the metadata to improve the search result. The composite information is tagged and important parts of the closest known prior art, the patent description and non-patent documents are tagged as meta-data to improve the search result.

Pseudo-code for the process to index IP documents in FIG. 15C is as follows:

For each Issued Patent DB and Published Application DB
a. Extract inventor names for each patent/application
b. Search for papers citing the inventor names
c. Extract names of prior art authors associated with prior art used to reject the application in the file history.
d. Search for papers citing the names of prior art authors
e. Extract concepts or important terms from the inventor publications/papers
f. Extract concepts or important terms from the current patent/application
g. Extract concepts or important terms from the prior art used to reject the current patent/application and extract concepts or important terms from non-patent publications of the prior art authors
h. Combine extracted concepts into meta-data describing the IP document.

FIG. 15D shows another embodiment for IP document indexing and searching. This embodiment trains the corpus with both patent and non-patent documents. In one implementation, meta-tags are generated for each patent document. Based on the patent document meta-tags (such as inventorship or cited prior art or claim wordings), the system searches non-patent publications for published papers written by the inventors. In addition, the system searches each cited prior art and extracts concepts or important terms in the prior art and supplements the metadata to improve the search result. The composite information is tagged and important parts of the closest known prior art, the patent description and non-patent documents are tagged as meta-data to improve the search result.

Pseudo-code for the process to index IP documents in FIG. 15D is as follows:

For each Issued Patent DB and Published Application DB
a. Extract inventor names for each patent/application
b. Search for papers citing the inventor names
c. For each cited prior art:
   c1. Extract names of prior art authors associated with prior art used to reject the application in the file history.
   c2. Search for papers citing the names of prior art authors
d. Extract concepts or important terms from the inventor publications/papers
e. Extract concepts or important terms from the current patent/application
f. Extract concepts or important terms from the prior art and publications from prior art authors.
g. Combine extracted concepts into meta-data describing the IP document.

Various features such as thematic features, title, cue phrase, and location can be used to determine salience of information for summarization in a meta-tag for search purposes. The location of the text can provide an important clue to its importance. In patent and patent applications, the leading text often contains a cogent summary or a cogent abstract. The independent claims can be used as another summary. In one embodiment, the phrases in the field of the invention and description sections are used. A combination of cue words, sentence location, and presence of title words in a sentence can also be used.

A corpus-based approach can be used to generate search meta data as well. A common use of a corpus is in computing weights based on term frequency. One attraction of corpus-based approaches is that the importance of different text features for any given summarization problem may be determined by counting the occurrences of such features in text corpora. In particular, an analysis of a corpus of human-generated summaries along with their corresponding full-text sources can be used to learn rules or techniques for automated search meta-tag generation. In addition to its usefulness in building empirically-based language models, there are many summarization problems beyond evidence combination for which they can be very useful, including the construction of accurate models of the types of constructions which occur in summaries and determining relationships between full-text and corresponding summaries.

In one implementation, a Bayesian classifier algorithm takes each test sentence and computes a probability that it should be included in a summary, based on the frequency of features in the full-text vectors and the vectors' labels (1 if it is to be included in a summary, 0 otherwise). The features used in these experiments can be sentence length, presence of fixed cue phrases (“in summary”, etc.), whether a sentence's location is paragraph-initial, paragraph-medial, or paragraph-final, presence of high-frequency content words, and presence of proper names.

In addition to Bayesian classifiers, decision tree rules can be used train summarizers to generate both generic and user-specific summarization rules for a corpus of articles with author-supplied abstracts, obtaining good results without the use of cue-phrases.

Various corpus-based techniques can be used for search metatag summarization. A three-part process can be used: topic identification (corresponding to the analysis phase), concept interpretation (corresponding to the transformation phase), and summary generation (corresponding to the synthesis phase). Topic identification aims at extracting the salient concepts in a document, with these salient concepts being used to weight sentences for extraction.

Other corpus-based methods such as those involving text categorization (binning documents into existing categories) and text clustering (grouping documents into classes) can be used. In this embodiment, each patent or IP document is labeled with its US classification, International classification and field of search as a topic label. In addition to the search classification, other information can be categorized. To illustrate, DTD elements such as application-number, application-number-series-code, assignee, assignee-type, authority-applicant, background-of-invention, biological-deposit, biological-deposit-citation, brief-description-of-drawings, brief-description-of-sequences, chemistry, chemistry-chemdraw-file, chemistry-mol-file, citation, cited-non-patent-literature, cited-patent-literature, citizenship, city, claim, class, classification-ipc, classification-ipc-edition, classification-ipc-primary, classification-ipc-secondary, classification-us, classification-us-primary, classification-us-secondary, continuation-in-part-of, continuation-of, continuations, continued-prosecution-application-flag, continuing-reissue-of, continuity-data, copyright-statement, corrected-republication-of, correspondence-address, country, country-code, cross-reference, cross-reference-to-related-applications, deposit-accession-number, deposit-date, deposit-description, deposit-term, depository, depository-name, detailed-description, determinant, diff, divide, division-of, doc-number, document-date, document-id, domestic-filing-data, drawing-reference-character, federal-research-statement, figure, filing-date, first-named-inventor, foreign-priority-data, grant-number, international-conventions, inventor, kind-code, markush-group, markush-item, mathematica-file, matrix, matrixrow, max, mean, median, middle-name, military-address, military-service, non-provisional-of-provisional, organization-name, paragraph-federal-research-statement, parent, parent-child, parent-patent, parent-pct, parent-status, partialdiff, party, patent-application-publication, pct-application, pct-publication, postalcode, power, prior-publication, priority-application-number, product, program-listing, program-listing-deposit, publication-filing-type, reissue-of, relevant-section, representative-figure, residence, residence-non-us, residence-us, sequence-list-new-rules, sequence-list-old-rules, subclass, subdoc-abstract, subdoc-bibliographic-information, subdoc-claims, subdoc-description, subdoc-drawings, summary-of-invention, technical-information, title-of-invention, us-agency, usc102e-date, usc371-date, among others, can be used as subtopics. Other DTD elements can be used as well. For each such topic, the top 300 terms scored by a term-weighting metric were treated as topic signatures; the terms in a test documents can be matched against these signatures to determine the document topics.

In another embodiment, multi-IP document summarization metatags are used. Here the number of documents to be summarized can range from large gigabyte-sized collections, to small collections, to just pairs of documents, and different methods may be needed for these different size ranges. There are many possible ways of characterizing relationships among documents, including part-whole relationships (e.g., cited prior art, claim scope, abstracts, hyperlinked documents, or “webs” of on-line information), differences of detail (a subsequent patent which explores an improvement to a prior patent in more detail), differences of perspective (different solutions to a problem), and temporal trends (e.g., developments leading to rapid growths in a particular, for example nanotechnology). The system eliminates redundancy of information across documents and exploits orderings among documents in intelligent ways. As discussed above, effective presentation and visualization strategies can be used to represent relationships.

In one embodiment, a search engine with multi-IP document summarization meta-tags exploits a connectivity model: the more strongly connected a text unit is to other units, the more salient it is. Paragraphs from one or more documents are compared in terms of similarity, using a measure based on similarity of vocabulary. Those paragraphs above a particular similarity threshold are linked to form a “text relationship map” graph. Paragraphs which are connected to many other paragraphs (i.e., “bushy nodes” in the graph) are considered salient. Summaries can then be generated by traversing a path along links, and extracting text from each paragraph along the path. In another embodiment, other cohesion relationships are used to construct user-focused multidocument summaries. A graph representation is generated whose nodes are term occurrences and whose edges are cohesion relationships (proximity, repetition, synonymy, hypernymy, and coreference) between terms. Given a user's query, a spreading activation algorithm explores links in from occurrences of query terms in each document's graph, to determine what information in each document is relevant to the query. The activated regions are then compared to extract query-related terms common to the documents, and query-related terms unique to each document. Sentences are then extracted based on weights of terms that are common (or unique). To minimize redundancy across extracts, sentence extraction can greedily cover as many different common (or unique) terms as possible. The authors explore a variety of presentation strategies, and present detailed results regarding the algorithmic complexity and performance of their programs.

In yet another embodiment, information extraction systems can be used to fill templates from text for pre-specified kinds of information, such as nano-structures. For example, relationships between different patents and patent applications are established by comparing and aggregating templates using various operators. Each operator takes a pair of templates and yields a more salient merged template, which can be compared with other operators. When applied to texts describing nano-structures (for example), the contradiction operator compares two templates that have the same structure but where the structure was formed using different sources or different applications, and identifies slots which have different values in each template. In the synthesis phase, the summarizer then uses text generation techniques to express any contradiction. Other operators include agreement and the superset operator, which fuses summaries together. The template techniques only apply to documents for which such templates can be reliably filled. The earlier embodiments described above, which work on unrestricted documents, cannot pinpoint such semantic relationships, using instead coarser representations of relationships in terms of term weight comparisons. There are also many intermediate levels of analysis; for example, one can construct models of all the named entities (e.g., inventors, assignees, claims) that occur in a collection of documents, and use that to group documents in interesting ways.

In yet another embodiment, the summarization metatag can be generated where the input and/or output need not be text. With the growing availability of multimedia information in our computing environments, non-text metatag is likely to be the most important of all. Two broad cases can be distinguished based on input and output: cases where source and summary are in the same media, and cases where the source is in one media, the summary in the other. Crossmedia information is used in fusing across media during the analysis or transformation phases of summarization, or in integration across media during synthesis. For example, representative images from video is used to analyze the topic structure of an accompanying closed-captioned text.

These strategies included presentation of multimedia summaries, full-source closed-captioned text, and the full video. The atomic summary presentation methods using closed-captioned text include topic summaries (“theme” terms—usually single words—extracted using Oracle's Context product), lists of proper names, and a single sentence summary (extracted by weighting occurrences of proper name terms). They also exploit direct summarization of the video, using an automatically extracted key frame (presented along with news source and date). In addition, there are a number of compound, mixed-media presentation strategies, which combine one or more video and textual strategies.

In one implementation, the indexing system also summarizing diagrams as metadata or meta-tags, such as the drawings or figures in the patent. In the analysis phase of summarization, structural descriptions of the diagram are constructed, along with analysis of text in the patent drawings, in the caption, as well as in the running text. The transformation phase produces summary diagrams by selecting one or more figures from a patent or patent application (analogous to sentence extraction), distilling a figure to simplify it (analogous to elimination by text compaction), or merging multiple figures (analogous to merging and aggregation of text). The final synthesis phase involves generation of the graphical form of the summary diagram.

The summary of diagrams can be constructed by extracting text from the images, the brief description of the drawings contained in the patent application, as well as the text in the description section that pertains to each diagram. From the foregoing, meta-data can be generated that characterizes the diagram. The metadata is subsequently used in searching the document.

To distill the figures, knowledge from the application text can be used. Combining the structure and caption information would allow the system to perform a sequence elision procedure, retaining only the extreme instances (and possibly the fifth or sixth instance to represent the intermediate appearances). The elided structure would be built using the same parse representation as the original. Using quantitative parameters from the original figure, the summary figure could be constructed. Alternatively, for patents that have a representative figure such as EPO patent, that figure can be used as the distilled figure. In another alternative, the first figure can be used as the distilled figure (as long as it is not noted as prior art figure).

When graphs such as flow-charts or block diagrams are represented as standard directed vertex-edge structures, there are topological reduction procedures that can be applied to distill the graphs to simpler form that can become metadata to aid in searching IP documents. Because they are based entirely on topology, these methods are domain independent. Link-sub graph-deletion (LSD) cam be applied to the diagrams. In LSD certain subgraphs of a larger graph are identified. Each such subgraph is a meganode, a set of vertices which is allowed to have only a single entering edge and a single exit edge. Otherwise it may have arbitrary internal connectivity. The vertices that precede and follow the subgraph can have arbitrary additional connectivity. The graph is reduced by deleting the entire subgraph. The new edge now receives an ordered pair of labels. The LSD procedure uses the maximal 2-connected subgraphs between nodes since, for example, a simple linked list would contain many 2-connected subgraphs.

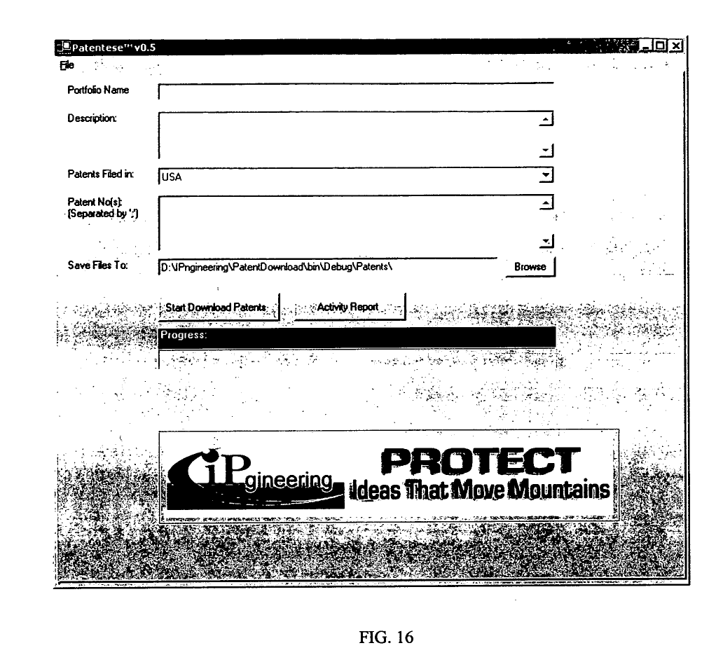

FIG. 16 illustrates an exemplary user interface for downloading IP documents with an integrated browser display at the bottom on the window to facilitate the display of updatable community messages. The browser window content is controlled by the server and can be updated at will. The integrated browser control can be used to notify the user community of important events (e.g. legal updates, product announcements, etc.) or for advertising.

In another embodiment, the user interface provides the user with a plurality of operating options accessible through clickable buttons, including “Buy IP Asset”; “Sell IP Asset”; “Register IP Asset”; “Appraise IP Asset”; “IP Escrow Service”; “Refer a Buyer”; and “IP Chat” buttons. Additionally, the user can access his or her specific interest by accessing a “Your Account” button, a “Your Listings” button, and a “Your Offers” button. Other buttons allow the user to utilize ancillary services such as “Trademark Search” button and “IP Monitoring” buttons. In this embodiment, the server supports an intellectual property portal that provides a single point of integration, access, and navigation through the multiple enterprise systems and information sources facing knowledge workers operating the client workstations. In an exemplary user interface to support IP asset trading, the user interface is a web-based user interface. The user interface allows a user to sign-on or sign-off the system.

The operations of exemplary buttons are discussed next. First, the Buy button allows a user to bid on a particular asset. In this embodiment, there are no fees charged to the buyer for this service and the seller pays fees. A user can simply search for desired IP assets and submit an offer using an interactive form. Upon receiving an offer, the system forwards it to the seller and notifies the buying party whether the offer has been accepted, rejected, or if there is a counteroffer. If the offer is accepted, the buyer will be mailed a purchase contract and detailed escrow instructions to sign, similar to those used in a real estate or business opportunity transaction.

For trademark applications, another embodiment can walk the user through whether he or she wishes to generate use-based applications or intent-to-use (ITU) applications, which are available if one has not yet used the mark on goods. The system prompts the user to list all the goods with which the mark will be used, or has been used. This should be carefully worded to ensure that the registration is not unduly narrowed. The system then requests a description of how the mark is used. A trademark must be used on (or in connection with) the actual goods—advertising is not sufficient use. The system can ask if the mark is a composite mark (such as a logo plus words), then the system presents the user with a choice of registering the word mark alone, the word/logo combination, or the logo alone. The system also guides the user with the selection of specimens with a use application. These are actual labels, tags, or packaging. The system can then suggest alternatives such as photographs that can be sent instead of specimens when the specimen is not fiat, or when it is too large.

The Appraise button provides an electronic valuation module to estimate the value of the IP assets. Factors evaluated include term of duration of rights; status of applications made in foreign countries and fights approved there; litigation with third parties; licensing status; technical nature of invention (three categories: basic technology, vastly improved technology and marginally improved technology); related patents; technical dominance of the IP asset, as judged by degree to which invention has been developed into a superior concept, extent and clarity of specification; clarity of range of technology if there is something unclear in the range of technology for which fights have been formed or there is concern over the occurrence of infringement-related disputes; relationship to use of IP rights possessed by third party; technical superiority to substitute technology; extent to which invention has been proven in real use; necessity of additional development for commercialization; markets for commercialization; transfer and distribution potential; inventors (or right-holders)'s intent to engage in continual research and development and the possibility of applying the results; potential restrictions on the places that it can be licensed to (such as limits on the term and region of implementation); the right-holder's ability to exercise its rights against infringing parties; the possibility that rights will be invalidated, canceled, or limited; the business potential of the invention; the possibility that substitute technology for the invention will be developed; the potential for competing or substitute products will appear; the ease that imitation products be easily manufactured; the ease of detecting infringing products; the size of the market, the market scale, the market share that is acquirable and the time frame for acquiring the targeted market share; the life span for the product's market; the price that a customer is willing to pay for the value generated by the relevant patent right; and the sustainability of the profit.

The sale of the IP asset can be facilitated using the system's brokerage and escrow service. The Escrow button allows a buyer and seller to have a neutral third party watch over the title transfer process. Through this service, a seller provides the systems with details of the transaction: the asset, selling price, current and future owners, and email addresses in an online form. Next, after confirming ownership registration and transaction details with each party via e-mail, the system generates a purchase agreement and escrow instructions for both parties to the transaction to sign. After the documentation is complete and returned to the system, a separate bank account is opened for this transaction, and the buyer is instructed to remit the funds to this account. The system works with the buyer and seller and a government agency such as a patent, trademark, or copyright office to properly affect the transfer of the asset. After the successful transfer, the funds are released from escrow to the seller (made payable to the registered owner), less transfer expenses. Typically, the system assumes that the seller pays the transfer fee unless otherwise instructed.

The Referral button allows a user to refer another company with potential assets to trade. If the trade occurs, the referring user gets a predetermined percentage of the transaction. This button encourages people to match parties together. The Chat button allows a user to chat with other users of the system on relevant topics such as IP trading.

The portal supports services that are transaction driven. Once such service is advertising: each time the user accesses the portal, the client workstation downloads information from the server. The information can contain commercial messages/links or can contain downloadable software. Based on data collected on users, advertisers may selectively broadcast messages to users. Messages can be sent through banner advertisements, which are images displayed in a window of the portal. A user can click on the image and be routed to an advertiser's Web-site. Advertisers pay for the number of advertisements displayed, the number of times users click on advertisements, or based on other criteria. Alternatively, the portal supports sponsorship programs, which involve providing an advertiser the right to be displayed on the face of the port or on a drop down menu for a specified period of time, usually one year or less. The portal also supports performance-based arrangements whose payments are dependent on the success of an advertising campaign, which may be measured by the number of times users visit a Web-site, purchase products or register for services. The portal can refer users to advertisers' Web-sites when they log on to the portal.

Yet another service supported by the portal is on-line trading of IP assets. By communicating through a wide area network such as the Internet, the portal supports a network-based community in which buyers and sellers are brought together in an efficient format to buy and sell intellectual property and other assets. The portal permits sellers to list assets for sale, buyers to bid on assets of interest and all users to browse through listed items in a fully-automated, topically-arranged, intuitive and easy-to-use online service that is available 24-hours-a-day, seven-days-a-week. Through such an IP trading portal, IP buyers can access a significantly broader selection of IP assets to purchase and sellers have the opportunity to sell their IP assets efficiently to a broader base of buyers. The portal overcomes the inefficiencies associated with traditional person-to-person trading by facilitating buyers and sellers meeting, listing items for sale, exchanging information, interacting with each other and, ultimately, consummating transactions.

Additionally, the portal offers forums providing focused articles, valuable insights, questions and answers, and value-added information about seed and venture financing and startup related issues, including accounting and consulting, commercial banking, insurance, law, and venture capital. The portal can connect savvy Internet investors with IP owners. By having access to the member's IP interests, the portal can provide pre-screened, high-quality investment opportunities that match the investor's identified interests. The portal thus finds and adds value to good deals, allows investors to invest from seed financing right through to the IPO, and facilitates the hand off to top tier underwriters for IPO. Additionally, members of the portal have access to a broad community of investors focused on the cutting edge of high technology, enabling them to work together as they identify and qualify investment opportunities for IP or other corporate assets.

Other services can be supported as well. For example, a user can rent space on the server to enable him/her to download application software (applets) and/or data—anytime and anywhere. By off-loading the storage on the server, the user minimizes the memory required on the client workstation 104-106, thus enabling complex operations to run on minimal computers such as handheld computers and yet still ensures that he/she can access the application and related information anywhere anytime. Another service is On-line Software Distribution/Rental Service. The portal can distribute its software and other software companies from its server. Additionally, the portal can rent the software so that the user pays only for the actual usage of the software. After each use, the application is erased and will be reloaded when next needed, after paying another transaction usage fee. When a user enters the portal for the first time, the portal presents the user with a simple form to collect basic information about the user, such as names and email addresses. After the user completes the form, he will be shown a legal agreement that he can sign online by clicking a button “Accept.” Alternatively, the user can request a copy of the statement to be downloaded or mailed to him by clicking “Mail Agreement”. The Mail Agreement affords the user with an opportunity to review the details of the agreement with a lawyer if necessary.

After the user signs the agreement by clicking the “Accept” button, he or she will be given a username and password and a registration identification, all of which will be mailed to him at the e-mail address entered in the registration form. The user will also be emailed a welcome package with introductory information about Intellectual Property.

After the user signs in for the first time, he will be guided to create a personal profile. The profile tracks the user's interests in various Intellectual Property News, Intellectual Property Laws, Seminars and Conferences, Network of Other People with similar interests, Intellectual Property Auctions & Exchanges, Intellectual Property Lawyers, Intellectual Property Businesses Intellectual Property Mediators between two companies contesting the same IP subject matter, Intellectual Property Forms (Non-disclosures, for example), Patent/Trademark/Copyright Updates and Market Place updates. Though all the services are available to all on the portal, this will personalize his areas of interest and send updates to his desktop directly. The portal can create personalized pages for members by dynamically serving-up the content to each user utilizing dynamic HTML, among others.

Once the user completes the personal profile, he will be prompted to download client software called an “intellectual property assistant” (assistant). The software runs constantly on the user's desktop and connects to the portal whenever the user connects to the Internet. The assistant process is hidden from the desktop process list so that the assistant process cannot be accidentally “killed” or removed by accident. The user can configure this assistant to suite his/her needs. The assistant will also allow the user to have a CHAT/Online Conference with other users registered with the portal.

After connecting to the portal, the assistant checks for the latest updates in his areas of Interest and show them in a small window at the bottom left portion of the screen. The client software performs multiple tasks, including establishing a connection to the portal; capturing demographic information; authenticating a user via a user ID and password; tracking Web-sites visited; managing the display of advertising banners; targeting advertising based on Web-sites visited and on keyword search; logging the number of times an ad was shown and the number of times an ad was clicked on; monitoring the quality of the online session including dial-up and network errors; providing a mechanism for customer feedback; short-cut buttons to content sites; and an information ticker for stocks, sports and news; and a new message indicator.

When the user accesses the portal, a background window is shown on his or her computer screen that is always visible while the user is online, regardless of where the user navigates. The window displays advertisements, advertiser-sponsored buttons, icons and drop-down menus. By clicking on items in the background window, users can navigate directly to sites and services such as intellectual property news, intellectual property laws, seminars and conferences, connections to others with similar interests, intellectual property auctions & exchanges, intellectual property lawyers, intellectual property businesses, intellectual property mediators between two companies contesting the same IP subject matter, intellectual property forms such as a non-disclosure agreement, patent/trademark/copyright updates and market place updates. Revenues can be generated by selling advertisements and sponsorships on the background window and by referring users to sponsors' Web-sites. The assistant shows advertisements while its window is visible. If the user clicks on an advertisement or news or related feature, the assistant will automatically launch the browser and take the user to the advertiser's site. The portal incorporates data from multiple sources in multiple formats and organizes it into a single, easy-to-use menu. Information is provided to the public free-of-charge with value added databases and services such as patent drafting assistance available to subscribers who pay a subscription fee. At a first level, the public can use without charge certain information domains in the portal. At a second level, individual inventors, very small companies and academic users can access the patent drafting software when they subscribe to a first plan with a predetermined annual membership fee and a transaction fee charged per patent application. At a third level, companies can access additional resources such as an IP portfolio management system, a docket management system, a licensing management system, and a litigation management system, for example. In this manner, the portal flexibly and cost-effectively serves a variety of needs. Other resources that the portal provides access to include intellectual property traders who mediate between potential licensors and licensees. These traders conduct accurate evaluations of patented technologies as property rights, as well evaluating their market value.

The portal also provides access to a bid, auction and sale system wherein the computer system establishes a virtual showroom which displays the IPs offered for sale and certain other information, such as the offeror's minimum opening bid price and bid cycle data which enables the potential purchaser or customer to view the IP asset, view rating information regarding the IP asset and place a bid or a number of bids to purchase the IP asset.

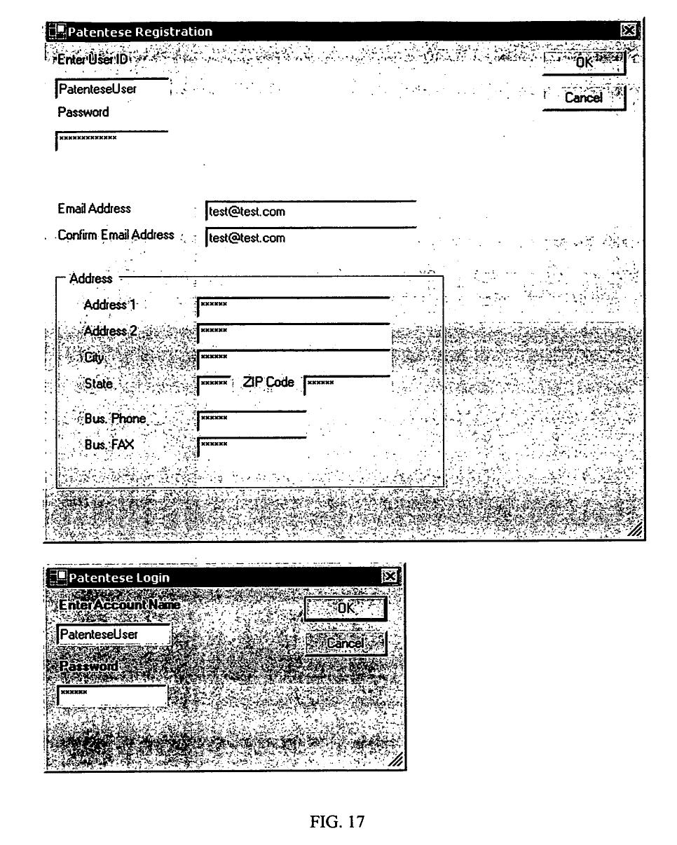

The portal has access to IP search engines that continuously search the web and identify information that is of interest to its users. These search engines will use the user profiles to search the web and store the results in the user folders. This information is also relayed to the users using the assistant. The portal delivers focused IP contents to interested subscribers and indirectly drives these subscribers and their businesses to innovate. FIG. 17 shows one embodiment of a user registration and login user interface to support the development of an IP user community. By registering and then logging in, each user in the community can be easily identified and communicated with. The development of a definitive IP user community has intrinsic value as a marketing and communication channel. The integrated browser control in FIG. 16 can be used to communicate with the IP user community.

An intelligent agent to aid the search engine in located relevant patent prior art is discussed in more detail next. The agent operates with a knowledge warehouse, which has a representation for the user's world, including the environment, the kind of relations the user has, his interests, his past history with respect to the retrieved documents, among others. Additionally, the knowledge warehouse stores data relating to the external world in a direct or indirect manner to enable to obtain what the assistant needs or who can help the electronic assistant. Further, the knowledge warehouse is aware of available specialist knowledge modules and their capabilities since it coordinates a number of specialist modules and knows what tasks they can accomplish, what resources they need and their availability. Upon powering up or log-on, the software agent retrieves a previously stored user profile. Next, it retrieves the environmental data such as the search subject matter, the time of execution, and other outstanding searches. Once the environment has been assessed, the agent executes one or more searches automatically on behalf of the user.

The user can set different profiles each reflecting an interest area. Among the different preferences, the user can select the types of archives he is interested in, e.g., processor IP, dental IP, nano IP, among others. He can also set a personal list containing the sites in which documents of user's interest are found more frequently. Alternatively, a profiler transparently captures the user activities, and based on the actions taken as well as the time taken to perform the action, allows the electronic assistant to predict next user actions based on past observations and hypothesis. In this manner, the assistant keeps tracks of the evolution of the user's interests by maintaining a dynamic profile that takes the user's behavior into account. The specificity of the profile increases with the user's awareness about the available information and how to get it. The possibility of a relevance feedback is particularly important in the context of the final system. Using the user's profile, the assistant can in turn launch specialized agents to navigate through the network hunting for information of interest for the user. In this way, the user can be alerted when new data that can concern his interest areas appear.

To avoid resource hogging, the agent requests a search budget from the user. The budget may be monetary or may be time spent performing the search. Next, the routine requests or infers a search domain. The search domain, based on prior user history and preference, may be displayed on the screen for the user to approve. A suggested prioritization of the search, based on prior user history and preference, may be displayed on the screen for the user to approve. Next, the electronic assistant generates a search query based on a general discussion of the search topic by the user. The assistant then refines the search query as discussed above, for example it expands the search query using a thesaurus to add related terms and concepts. Further, the assistant searches the computer's local disk space for related terms and concepts, as terms and concepts in the user's personal work space is relevant to the search request. In this manner, based on its knowledge of the user's particular styles, techniques, preferences or interests, the information locator can tailor the query to maximize the search net. Next, the routine adds the query to the search launchpad database which tracks all outstanding search requests. The agent broadcasts the query to one or more information sources such as the PTO patent database or Google for publication database and awaits for search results. In place of Google, the agent can search for publications in on-line bookstores which provide content on-line such as Amazon.com. Upon receipt of the search results, the agent communicates the results to the user, and updates its knowledge warehouse with responses from the user to the results. In this manner, the agent presents a list of keywords in the search which identifies a possible set of documents for which the user can choose a particular action. Then he can specify the number of items he wants and if there is a time in which he prefers to activate the search. The retrieved documents are shown to the user according to the preference values in the current profile. The assistant tracks the user's behavior concerning the documents retrieved in both surfing and query modes. After each search cycle in the surfing mode, the retrieved documents are proposed to the user who can decide to refuse or accept each of them. The rejected documents are stored in a database and successively compared with the sets of incoming documents in order to refine the boundaries of the search. Thus, if items in the incoming set are found similar to some of the rejected documents, the assistant discards the former. As a consequence the documents proposed to the user are closer to his actual interests. In the query mode, the user's requests are also used to refine the profile. The rejected documents are added to the database, while for each query a profile is extracted from the set of accepted items that the assistant adds to the profiles database. Thus, if the user has particular styles, techniques, preferences or interests, the intelligent electronic assistant dynamically adapts to said user styles, techniques, preferences or interests, updating said user styles, techniques, preferences or interests in said knowledge warehouse, and instructing said information locator to locate data of interest for said user based on said user styles, techniques, preferences or interests.

The process for carrying out the search is shown in more detail. The search routine or process checks if the allocated budget has been depleted. If so, the routine requests more resources to be allocated to the search process. Next, the routine checks if the user has increased the budget or not. If not, the routine kills the search requests and exits as it is out of resources. In this manner, the economic based competitive allocation system ensures that only worthwhile searches are performed.

In the event that the budget has not been exceeded, the routine checks if the previous search results are good enough that no additional search needs to be made, even if the deadline and remaining budget permits such search. If so, the routine simply exits. Alternatively, in the event that the remaining budget is sufficient to cover another search, the routine checks on the closeness of the deadline. If the deadline is very near, such as within a day or hours of the target, the routine elevates the priority of the current search to ensure that the search is carried out in a timely fashion. The routine checks if it is time for an interval search, which is intermediate searches conducted periodically in satisfaction of an outstanding search request. If so, the routine sends the query to the target search engine(s).

The search tracks the intercepted URLs involving the formation of new searches cause the spawning of new search processes that will execute either through a single completion of a multiple engine search or through an indefinite number of search completions, each occurring at an interval specified by the user at the time of the initial request. Searches can be scheduled through the search engines currently available on the web such as Lycos, Web Crawler, Spider etc., at a constant interval set by the user. The assistant optionally reports to its user if a specific search is fulfilled or in progress through the inclusion of a footer to pages currently displayed on the user's browser.

Once the query has been submitted, the electronic assistant periodically checks the status of the search. If the current search engine has failed for some reason, the agent reroutes the search to reach a mirror search engine, or substitute a less preferred, but operational search engine. If new information has been located, the routine informs the user such that the user is notified if a specific search has new search result since last database retrieval. Otherwise, the agent puts itself to sleep to await the next interval search.

In this manner, the assistant automatically schedules and executes multiple IP information retrieval tasks in accordance with the user priorities, deadlines and preferences using the scheduler. The scheduler analyzes durations, deadlines, and delays within its plan in while scheduling the information retrieval tasks. The schedule is dynamically generated by incrementally building plans at multiple levels of abstraction to reach a goal. The plans are continually updated by information received from the assistant's sensors, allowing the scheduler to adjust its plan to unplanned events. When the time is ripe to perform a particular search, the assistant spawns a child process which sends a query to one or more remote database engines. Upon the receipt of search results from remote engines, the information is processed and saved in the database. The incoming information is checked against the results of prior searches. If new information is found, the assistant sends a message to the user.

While the result of the search is displayed to the user, his or her interaction with the search result is monitored in order to sense the relevancy of the document or the user interest in such search. Alternatively, in the event that the user has reviewed every document found during the instant search, the routine computes the time the user spent on the entire review process, as well as the time spent on each document. Documents with greater user interest, as measured by the time spent in the document as well as the number of hypertext links from each document, are analyzed for new keywords and concepts. Next, the new keywords and concepts are clusterized using cluster procedures such as the k-means clustering procedure known in the art and the resulting new concepts are extracted. Next, the query stored in the database is updated to cover the new concepts and keywords of interest to the user. In this manner, the procedure adapts to the user interests and preferences on the fly so that the next interval search is more refined and focused than the previous interval search.

The process for applying the electronic assistant as a memory augmentation unit for the user is detailed. Upon receipt of a query, the agent searches the local disk space for data relevant to the context of the request. Next, it displays relevant documents in a window. The agent checks if the user exhibits any interests in the documents displayed in the window. If so, the agent captures the time and the number of search results, which can be hypertext links the user selected while viewing the displayed document. The information captured is analyzed where key terms are added to the new search metadata for subsequent analysis of user preferences and patterns.

The IP search engine described above can be used to trade IPs. For instance, a user developing a new product may be interested in purchasing pending applications that are important to the user but may be a candidate for trimming from another company's list for a variety of reasons, including withdrawal from a particular market for strategic reasons or company is no longer in business or no longer has the budget to sustain the application. Embodiments of the system facilitate and enhance the licensing and trading of IP assets. The system supports purchasing or selling of intellectual property related products and services with a computerized bid, auction and sale system over a network such as the Internet. The techniques provide IP owners with access to an open market for trading IP. The techniques support a service-based auction network of branded, online auctions to individuals, businesses, or business units. The techniques offer a quick-to-market, flexible business model that can be customized to fit the IP needs of any industry and target technology.

In one aspect, a system supports trading of intellectual property (IP) with a user interface to accept a request to trade an IP asset; and a database coupled to the user interface to store data associated with one or more IP assets, the database supporting the trading of the IP asset. Implementations of the system can include one or more of the following. The system offers one of more of the following: a trade IP user interface to accept a request to trade an IP asset; a buy IP user interface to accept a request to buy an IP asset; a sell IP user interface to accept a request to sell an IP asset; a register IP user interface to accept a request to register an IP asset; an appraise IP user interface to accept a request to appraise an IP asset; and an escrow IP user interface to accept a request to place an IP into escrow service. The system can provide an IP chat-room. The system can provide a network adapted to electronically link IP specialists to provide value added services to the patent application. The system can match IP specialists such as attorneys, draftsmen, IP marketers and inventors on request. The IP specialists can be paid on a commission basis. An automated patent drafting system can be used to generate a patent application having a required sequence. The system can provide an online platform for selling and buying patentable ideas or pending patent applications and where parties can list and search for applications that are about to be abandoned. The network is the Internet and wherein clients access the system using a browser. A patent information management (PIM) system can be used to display information for a user to manage the user's IP and to communicate with other users relating to the IP. The PIM provides information on pending activities relating to an IP asset and wherein the user can drill down to get additional information on the IP asset.

On-line trading is done through a network-based community in which buyers and sellers are brought together in an efficient format to buy and sell intellectual property and other assets. The system permits sellers to list assets for sale, buyers to bid on assets of interest and all users to browse through listed items in a fully-automated, topically-arranged, intuitive and easy-to-use online service that is available 24-hours-a-day, seven-days-a-week. The system overcomes the inefficiencies associated with traditional person-to-person trading by facilitating buyers and sellers meeting, listing items for sale, exchanging information, interacting with each other and, ultimately, consummating transactions. Through such a trading place, buyers can access a significantly broader selection of assets to purchase and sellers have the opportunity to sell their assets efficiently to a broader base of buyers. The techniques support real time and interactive auctions that allows bidders place bids in real time and compete with other bidders around the world using the Internet. The techniques allow customer bids to be automatically increased as necessary up to the maximum amount specified, so bids can be raised and auctions won even when bidders are away from their computers.

In one aspect, the techniques provide a single window to a user's most commonly used desktop information. The window provides a portal that helps the user protect new ideas or concepts in an economical, efficient and fast manner by providing the user with access to a network of IP lawyers for assistance in finalizing the applications. The portal also links the user with IP related businesses such as those who specialize in trading or mediating IP related issues. The portal also provides access to non-IP resources, including venture capitalists and analysts who track evolving competition and market places. The portal remains with users the entire time they are online and can automatically update the users on any competing products or any new patents or trademarks granted in their areas of interest. Once users are logged-in, the portal remains in full view throughout the session, including when they are waiting for pages to download, navigating the Internet and even engaging in non-browsing activities such as sending or receiving e-mail.

The constant visibility of the portal allows advertisements to be displayed for a predetermined period of time. Thus, the techniques provide Internet advertisers and direct marketers a number of advantages in realizing the full potential of online advertising. The techniques capture the users' profiles regarding their areas of interests, current occupations, company affiliations, demographic information (such as age, gender, income, geographic location and personal interests), and the users' behavior when they are online with the system. As a result, the system can deliver targeted advertisements based on information provided by users, actual Web sites visited, Web-site being viewed, or a combination of this information, and measure their effectiveness. Thus, the system allows online advertisers to successfully target their audiences, largely due to the availability of a precise demographic and navigation data on users. The system also allows advertisers to receive real-time feedback and capitalize on other potential advantages of online advertising. The techniques provide an easy and efficient method for generating traffic to Web sites, strengthening customer relationships, which ultimately increases revenues on unused IP assets.

In another aspect, the system provides an online platform for selling and buying ideas without patent protection or ideas with pending patent applications that otherwise are ready to be abandoned. The system allows parties to list and search for applications that are about to be abandoned simply because the inventors or owners of the application do not have financial resources to pursue the prosecution of these applications for financial or other reasons. The system provides a win-win solution for the inventors and for investors who see potential revenue opportunities.

Although the foregoing relates to an issued patent document, the same can be applied to pending applications as well. Also, the analysis process and embedding of information are applicable to a number of patent offices including the USPTO, EPO, JPO, and KIPO, among others. Further, although PDF is mentioned as one embodiment, other document formats are contemplated. Examples of such document formats include Microsoft's XDoc, HTML documents, XML documents, TIFF documents, JPEG documents, and multimedia documents, among others. XDocs (InfoPath) is Microsoft's new XML-based forms and document solution. XDocs is optimized for the Microsoft Office System, picture it as an ecosystem that represents a combination of familiar and easy-to-use programs, servers and services that are intended to help information workers address a broader array of business challenges. It encompasses the core Microsoft Office client applications, as well as FrontPage 2003, Visio 2003, Project 2003 and Publisher 2003, as well as new desktop applications, InfoPath 2003 and OneNote 2003. With the addition of servers, such as SharePoint Portal Server 2003, Project Server 2003 and the Live Communications Server 2003, users will be able to take advantage of deeper collaboration capabilities and communication tools like live chats within familiar productivity applications right from their PCs.

While certain exemplary embodiments have been described in detail and shown in the accompanying drawings, it is to be understood that such embodiments are merely illustrative of and not restrictive on the broad invention, and that this invention is not to be limited to the specific arrangements and constructions shown and described, since various other modifications may occur to those with ordinary skill in the art.

1. A method for providing an electronic file for intellectual property applications, comprising:
authenticating a user with a patent office computer;
receiving electronic file wrapper information from a patent office computer; and
generating a single electronic document for an entry in the electronic file wrapper information, the document having all images for the entry consolidated therein.

2. The method of claim 1, wherein said document is a portable document format (PDF) document.

3. The method of claim 1, comprising generating a text-searchable PDF document containing all images for the entry.

4. The method of claim 1, wherein the electronic file wrapper information includes a plurality of entries each having a mail-room date and a document description, comprising generating a single electronic document for each entry in the electronic file wrapper information.

5. The method of claim 1, comprising downloading each image for an entry.

6. The method of claim 1, comprising downloading a compressed file having all images for the entry.

7. The method of claim 1, wherein the electronic file includes a folder containing at least one file for each entry, comprising periodically updating folder content with one or more new entries from the patent office electronic file wrapper information.

8. The method of claim 1, comprising generating a single electronic document for each new entry in the electronic file wrapper information, the document having all images for the entry consolidated therein.

9. The method of claim 1, wherein the electronic file wrapper information includes a plurality of entries each having a mail-room date and a document description, comprising providing docketing information based on the mail-room date.

10. The method of claim 9, comprising generating a docket entry for one or more of the following: Information Disclosure Statement filing, foreign filing, Office Action response, response to missing part, notice of appeal, appeal brief, reply to response to appeal brief, notice of allowance, and annuity payment.

12. The method of claim 9, comprising generating a docketing message to a recipient.

13. The method of claim 12, comprising coding the docketing message to indicate the degree of urgency of the docketing message.

14. The method of claim 1, comprising automatically generating and automatically filing one or more electronic documents with the patent office computer.

15. The method of claim 11, wherein the electronic documents include one or more of the following: utility patent applications, Provisional applications, Biosequence listings for applications previously filed in paper, Pre-grant publication resubmissions for previously filed applications, where the applicant wants an amended, redacted, voluntary, or republication specification to be published rather than the application as originally filed, Subsequent bio-sequence submissions, Multiple assignments, Electronic Information Disclosure Statements (eIDS), Design applications, New plant applications, Corrected or revised patent application republications, Reissue applications, International Patent Cooperation Treaty (PCT) applications, and Reexamination requests.

16. The method of claim 1, comprising displaying the electronic document in a tri-fold format.

17. The method of claim 1, comprising saving user annotation in the document.

18. The method of claim 1, comprising
searching one or more remote databases for one or more relevant intellectual properties (IPs); and
performing a network analysis on the relevant IPs.

19. A method for providing an electronic file for intellectual property (IP) applications, comprising:
searching one or more databases for one or more relevant IPs;
performing a network analysis on the relevant IPs; and
determining IPs required to provide freedom to operate.

20. The method of claim 19, comprising acquiring the least number of IPs to provide freedom to operate.

21. The method of claim 19, comprising:
receiving electronic file wrapper information from a patent office computer; and
generating a single electronic document for an entry in the electronic file wrapper information, the document having all images for the entry consolidated therein.

22. A method to retrieve intellectual property documents, comprising:
receiving an assignee name in lieu of a patent number, published application number or application serial number; and
retrieving copies of all patents and published patent applications matching the assignee name.

23. A method to retrieve intellectual property documents, comprising:
receiving an application serial number conforming to a format aa/bbbbbb;
retrieving a published patent application matching the bbbbbb; and
generating a single electronic document having all pages of the patent application consolidated therein.

24. The method of claim 23, wherein the retrieving locates a plurality of matching patent applications, further comprising selecting the patent application whose Series Code matches aa.
